(19) United States
(12) Patent Application Publication
(10) Pub. No.: US 2009/0203526 A1
(43) Pub. Date: Aug. 13, 2009

(54) METHOD OF CONTROLLING UNWANTED VEGETATION

(75) Inventors: Patrick Haikal, Denver, CO (US); Brian Schilling, Edmonton (CA); Tony Zatylny, Calgary (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Arysta LifeScience North America, LLC

(21) Appl. No.: 12/368,722

(22) Filed: Feb. 10, 2009

Related U.S. Application Data
(60) Provisional application No. 61/027,958, filed on Feb. 12, 2008.

(51) Int. Cl. A01N 57/00; A01N 43/42; A01P 13/02

(52) U.S. Cl. 504/194; 504/247

(57) ABSTRACT

The present invention is a method of controlling or preventing unwanted vegetation in a crop planting site by applying a traditionally recognized post-emergent herbicide to a planting site in a pre-emergent application and subsequently applying the same or different traditionally recognized post-emergent herbicide to the planting site in a post-emergent application. Further, a reduction in the amount of a post-emergent herbicide necessary for controlling unwanted vegetation in a crop planting site can be achieved by providing a pre-emergent treatment including a traditionally recognized post-emergent herbicide to the planting site and subsequently providing a post-emergent treatment of a reduced amount of the same or different post-emergent herbicide.

### CROSS-REFERENCE TO RELATED APPLICATIONS

This application claims the benefit of U.S. Provisional Application No. 61/027,958, filed Feb. 12, 2008, which is incorporated by reference in its entirety.

### BACKGROUND OF THE INVENTION

1. Field of the Invention

The present invention relates generally to a method of controlling or preventing unwanted vegetation in a crop planting site and reducing the amount of post-emergent herbicide necessary for controlling or preventing unwanted vegetation.

2. Description of Related Art

Over time, the control of unwanted vegetation in crop planting sites according to traditional treatment schemes has been strained. In some cases, various weed species have developed resistance to certain post-emergent herbicides, such as glyphosate, as well as other post-emergent herbicides. As a result, application rates and quantities have been increased in an effort to gain control over the unwanted vegetation. However, this approach merely exacerbates the resistance problem and increases the cost of crop production at a given site. Thus, attempting to maintain weed control by merely increasing the post-emergent application dose of a given herbicide is not a viable approach for long term management and control of unwanted vegetation in crop planting sites.

Additionally, the increasing use of high application rates of post-emergent herbicides may actually prove to be detrimental to crop growth. Likewise, the increased application of herbicides may negatively impact the local environment. Accordingly, it is increasingly necessary to balance weed control with environmental needs. This is a difficult (if not impossible) task, though, since the environmental considerations tend to necessitate the use of reduced quantities of herbicidally active substances to control unwanted vegetation.

Accordingly, there remains a need for a more effective method of controlling or preventing the growth of unwanted vegetation in planting sites. Further, there remains a need for a method of controlling unwanted vegetation by using reduced quantities of herbicidally active substances.

### BRIEF SUMMARY OF THE INVENTION

The present invention satisfies at least some of the aforementioned needs by providing a method of controlling and/or preventing unwanted vegetation comprising applying at least one herbicidally active substance typically recognized as a post-emergent herbicide to a crop planting site, but wherein the typically recognized post-emergent herbicide is applied in a pre-emergent fashion. The method can further comprise applying at least one post-emergent herbicide to the planting site in a post-emergent fashion. For instance, embodiments of the present invention provide a method of controlling or preventing unwanted vegetation in a crop planting site by applying a typically recognized post-emergent herbicide, such as flucarbazone, propoxycarbazone, thiencarbazone, or pyroxsulam, to a planting site in a pre-emergent application, and subsequently applying the same or different post-emergent herbicide to the planting site in a post-emergent application.

In another aspect, the present invention provides a method of reducing the amount of a post-emergent herbicide necessary for controlling unwanted vegetation in a crop planting site by providing a pre-emergent treatment including a typically recognized post-emergent herbicide, such as flucarbazone, propoxycarbazone, thiencarbazone, or pyroxsulam, to the planting site. In further embodiments, the method comprises subsequently providing a post-emergent treatment comprising a reduced amount of a post-emergent herbicide as compared to the amount of post-emergent herbicide required to control unwanted vegetation in the absence of the pre-emergent treatment.

### DETAILED DESCRIPTION OF THE INVENTION

The present invention now will be described more fully hereinafter through reference to various embodiments. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

Chemical compounds commonly classified as herbicides can have a variety of modes of action. Two general classifications are pre-emergent herbicides and post-emergent herbicides. Pre-emergent herbicides are typically understood as being compounds that, via a certain mode of action, prevent germination of weeds while in the seed or spore state or prevent emergence of a germinating seed above the ground. Thus, pre-emergent herbicides are typically applied to the soil where weed seeds are or may be present. As such, pre-emergent herbicides are typically applied to the soil prior to weed and crop emergence (i.e., emergence above ground). Pre-emergent herbicides can be applied prior to or after the planting of a desired crop. On the other hand, post-emergent herbicides are typically understood as being compounds that, via a certain mode of action, kill weeds that have already emerged (i.e., are actively growing plants). Post-emergent herbicides often function by disrupting some cellular function of the weed and are thus typically applied to some part of the actual weed plant (e.g., plant leaves, stems, flowers, stalks, or roots). Thus, pre-emergent herbicides and post-emergent herbicides are typically recognized as being distinct types of herbicides in light of their distinct modes of action (i.e., either preventing seed germination or acting on actively growing plants).

In light of the availability of compounds having pre-emergent herbicidal activity and compounds having post-emergent herbicidal activity, methods of controlling weeds (which are understood to include any unwanted vegetation in or around a desired crop plant) typically include applying a pre-emergent herbicide prior to weed germination or applying a post-emergent herbicide after weed germination and emergence. As pointed out above, such regimens increasingly require greater amounts of herbicides, and this is in direct contradiction with many environmental and safety requirements. According to the present invention, however, it has been discovered that application rates for chemical compounds typically recognized as post-emergent herbicides can be greatly reduced through combination with pre-emergent application of the same or different chemical compounds that are also typically recognized as post-emergent herbicides.

The present disclosure describes the use of a typically-recognized post-emergent herbicide in a pre-emergent fashion. Reference to application in a pre-emergent fashion is thus not to be confused with the underlying chemical activity of the compound (e.g., preventing seed germination versus acting on actively growing plants). The present invention does not necessarily arise from a re-classification of given compounds. Rather, the invention arises from the realization that some compounds having post-emergent activity against actively growing plant material can also be effective if applied in a pre-emergent fashion. The underlying theory for this realization is discussed further below.

Disclosure around applying a herbicide in a pre-emergent fashion relates to the timing of the application in relation to emergence of a weed, a crop plant, or both. For example, in some embodiments, application in a pre-emergent fashion (i.e., “pre-emergent application” or “pre-emergent treatment”) can mean application before visible emergence of any plant material at a given locus. In other embodiments, application in a pre-emergent fashion can mean application before emergence of a desired crop plant at a given locus. In yet other embodiments, application in a pre-emergent fashion can mean application before emergence of a weed at a given locus. In still other embodiments, application in a pre-emergent fashion can mean application before or after emergence of a weed but before emergence of a crop at a given location. Post-emergent application (i.e., “applying in a post-emergent fashion), as used herein, should be understood as describing the application of a herbicidally active substance after emergence of unwanted vegetation and, optionally, after emergence of a crop at a given locus.

According to embodiments of the present invention, unwanted vegetation can be controlled (i.e., stunt growth, wither, or die) by applying a chemical compound typically recognized as a post-emergent herbicide on or around a crop planting site in a pre-emergent fashion and later applying a post-emergent herbicide to the crop planting site in a post-emergent fashion. In certain embodiments, the growth and/or spread of unwanted vegetation is controlled by applying a typically recognized post-emergent herbicide to a crop planting site prior to the emergence of unwanted vegetation coupled with applying a commercially available post-emergent herbicide to the crop planting after emergence of unwanted vegetation.

In certain embodiments according to the present invention, a traditionally recognized post-emergent compound can be applied to a crop planting site in a pre-emergent fashion, and the same compound can also be applied to the crop planting site in a post-emergent fashion. Beneficially, pre-emergent application of the traditionally recognized post-emergent compound to a crop planting site can reduce the rate or amount of any commercially available post-emergent herbicide required to effectively control (i.e., stunt growth, wither or kill) unwanted vegetation in the crop planting site when applied only in a post-emergent fashion. Further, in various embodiments, the total amount of herbicidally active compound utilized to control unwanted vegetation is no greater then the amount of herbicidally active compound required to control unwanted vegetation by post-emergent treatment alone. In a preferred embodiment, the total amount of herbicidally active compound utilized to control unwanted vegetation is less than the amount of herbicidally active compound required to control unwanted vegetation by post-emergent treatment alone.

Embodiments of the present invention can be used to control established unwanted vegetation in the vicinity of a crop planting site infested with unwanted vegetation. Although a locus of unwanted vegetation may already be established, this existing locus of unwanted vegetation can be effectively confined from spreading to other planting sites or increasing in viable population within the crop planting site. Controlling and/or confining a pre-existing locus of unwanted vegetation from spreading to other crop planting sites proximate to the infested planting site can be achieved, according to various embodiments of the present invention, by applying a compound or compounds traditionally recognized as a post-emergent herbicide to the infested crop planting site followed by applying a commercially available post-emergent herbicide after additional emergence of unwanted vegetation. Thus, preventing an increase in viable unwanted vegetation within the crop planting site by controlling the growth of additional unwanted vegetation. Alternatively, the traditionally recognized post-emergent compound(s) can also be applied to the surrounding areas where unwanted vegetation has not emerged and followed by applying a commercially available post-emergent herbicide to the surrounding areas (e.g., proximate planting sites without emerged unwanted vegetation) upon emergence of unwanted vegetation in the surrounding crop planting sites. Thus, the spread of viable, unwanted vegetation to surrounding crop planting sites can be controlled.

In one aspect of the present invention, a method for controlling or preventing the growth and/or spread of unwanted vegetation is provided. In one embodiment, a crop planting site is treated with an effective amount of a compound or compounds traditionally recognized as a post-emergent herbicide by applying the compound in a pre-emergent fashion. Later, a commercially available post-emergent herbicide is applied in a post-emergent fashion to the planting site and/or to a locus of unwanted vegetation directly. For instance, a post-emergent herbicide can be directly applied to the foliage of each individual sprout of unwanted vegetation if desired.

In various embodiments, the pre-emergent application of a traditionally recognized post-emergent herbicide to a crop planting site can be performed prior to the seeding of the desired crop (i.e., “pre-plant”), while in other embodiments the pre-emergent application of the traditionally recognized post-emergent herbicide can be applied at some time after the seeding of the crop (i.e., “post-plant”). Thus, “plant” or “planting” refers to the intentional sowing of a desired crop plant. In one alternative embodiment, the traditionally recognized post-emergent herbicide can be applied at a first time prior to the seeding of the crop (i.e., pre-plant) and again at a second time after seeding of the crop (i.e., post-plant). Further, the post-emergent application can include any commercially available post-emergent herbicide. Accordingly, in one embodiment, the traditionally recognized post-emergent herbicide can be applied to a crop planting site in a pre-emergent fashion at any time prior to emergence of unwanted vegetation followed by a second application of the same compound(s) after emergence of unwanted vegetation.

Another aspect of the present invention comprises a method of reducing the amount of a post-emergent herbicide necessary for controlling unwanted vegetation in a crop planting site. Surprisingly, it has been found that by using chemical compounds typically recognized as post-emergent herbicides in a pre-emergent fashion, the total quantity of herbicidally active agent required for controlling unwanted vegetation can be reduced relative to the amount of herbicidally active agent required by post-emergent treatment alone. In one embodiment, a pre-emergent treatment comprising a chemical compound typically recognized as a post-emergent herbicide is provided to a crop planting site prior to emergence of unwanted vegetation. The pre-emergent treatment of the crop planting site with the chemical compound typically recognized as a post-emergent herbicide mitigates the future seeding, growth, and spread of unwanted vegetation such that a reduced amount of the same or different traditionally recognized post-emergent herbicide can be applied to the planting site after emergence of unwanted vegetation. In another embodiment, the pre-emergent treatment of the typically recognized post-emergent herbicide is provided to a crop planting site after emergence of some weeds but before emergence of the crop plant.

In one preferred embodiment, wherein a typically recognized post-emergent herbicide is used in a pre-emergent fashion, the amount of post-emergent herbicides required to control the growth and spread of unwanted vegetation is beneficially reduced. Further, in yet another preferred embodiment, the total amount of herbicidally active agent is reduced by utilizing a typically recognized post-emergent herbicide in a pre-emergent application. As such, the total amount of herbicidally active agent applied to the planting site by the pre-emergent and post-emergent treatments to control unwanted vegetation is less than the amount required by post-emergent treatement alone. Accordingly, an overall reduction in the amount of herbicide applied is achieved. Thus, the post-emergent treatment is used as a clean-up treatment to merely finalize the destruction of the unwanted vegetation.

According to various embodiments, the aforementioned reduction in the application of herbicidally active agent can be obtained by applying in a pre-emergent fashion a chemical compound typically recognized as a post-emergent herbicide. Such pre-emergent application of the post-emergent herbicide can be (i) pre-plant, (ii) post-plant, or (iii) both pre-plant and post-plant. Afterward, a commercially available post-emergent herbicide, which can be the same compound applied to the crop planting site in a pre-emergent application, is applied to the crop planting site in a post-emergent treatment to finalize the destruction of the unwanted vegetation.

The pre-emergent application of the traditionally post-emergent herbicide can comprise application of a single herbicidally active compound or can comprise application of multiple herbicidally active compounds so long as at least one of the herbicidally active compounds is one that is typically recognized as a post-emergent herbicide. Accordingly, in certain embodiments, the pre-emergent application can comprise application of a single post-emergent herbicide, multiple post-emergent herbicides, a single post-emergent herbicide in combination with one or more traditional pre-emergent herbicides, or multiple post-emergent herbicides in combination with one or more traditional pre-emergent herbicides. In a preferred embodiment, the methods of the invention comprise pre-emergent application of a single post-emergent herbicide and post-emergent application of a single (same or different) post-emergent herbicide.

As used herein, the term “unwanted vegetation” is understood to include any vegetation growing at a crop plant site or locus of seeded and otherwise desired crop, where the vegetation is any plant species other than the seeded or desired crop. The present invention is beneficial in that it can be used to control the growth of such unwanted vegetation by stopping the growth of the unwanted vegetation, inducing withering of the unwanted vegetation, and eventually killing the unwanted vegetation.

The ability to control the unwanted vegetation is surprising in that a compound typically recognized as having only post-emergent activity can be effective in a pre-emergent application. As noted above, post-emergent compounds are so designated because of their chemical mode of action (i.e., because they act on a cellular function of the growing plant). Likewise, pre-emergent herbicides as so designated because of their mode of action (i.e., because they act by preventing germination). It is surprising, then, that a compound that is effective as an herbicide because it has post-emergent activity would be effective for controlling weeds when applied in a pre-emergent fashion (i.e., when there are no actively growing weeds to act upon).

As more fully described below, this is possible according to the present invention because of the discovery that certain post-emergent herbicides have a residual soil activity such that the pre-emergent application forms a soil layer of the herbicide that can act on weeds immediately upon emergence. Since seedlings are typically less hardy than mature plants, a lesser amount of an herbicide can be effective to kill the weed in the seedling stage. Thus, many sprouting weeds are killed before reaching a mature stage, and the surviving weeds can be weakened such that the post-emergent application of a post-emergent herbicide in a lessened amount can be effective to kill the surviving weeds. In other words, the pre-emergent application of post-emergent herbicides having the necessary residual soil activity reduces the number weeds that reach maturity at a crop locus and significantly weakens those weeds that do reach maturity, and less post-emergent herbicide is needed to effectively control weeds at the crop locus. This results in a net application of post-emergent herbicide that is less than the necessary application rate when only a post-emergent application is made. This is further illustrated in the Examples provided below.

Each typically recognized post-emergent herbicide used in a pre-emergent application can exhibit a different time duration of residual soil activity. Thus, the timing of the pre-emergent application of the typically recognized post-emergent herbicide according to certain embodiments of the present invention can be selected based on the duration of residual soil activity exhibited by the chosen typically recognized post-emergent for pre-emergent application. In particular, embodiments of the present invention comprise applying a typically recognized post-emergent herbicide in a pre-emergent application such that the soil layer of the typically recognized post-emergent herbicide can be sufficient to act on weeds immediately upon sprouting. Accordingly, in certain embodiments the residual soil activity in accordance with the present invention comprises from about 1 day to about 30 day, from about 5 days to about 25 days, from about 10 days to about 20 days, or from about 13 days to about 17 days. As such the timing for applying a typically recognized post-emergent herbicide in a pre-emergent application can comprise from just prior to emergence of unwanted vegetation up to about 30 days prior to emergence of unwanted vegetation, up to about 25 days, up to about 20 days, or up to about 17 days prior to emergence of unwanted vegetation. Merely by way of example, one embodiment of the present invention comprises the application of flucarbazone in a pre-emergent application. Since flucarbazone can exhibit sufficient residual soil activity for about 13 to about 17 days, flucarbazone preferably can be applied to a crop planting site from just prior to emergence of unwanted vegetation to approximately 13 to 17 days prior to the emergence of unwanted vegetation.

Specific embodiments of the present invention comprise the pre-emergent application of certain post-emergent herbicides having a residual soil activity. The residual soil activity can be such that the pre-emergent application forms a soil layer of the herbicide that can act on weeds immediately upon emergence. A particular herbicide can be identified as having a residual soil activity according to embodiments of the present invention using a variety of methods. For example, residual soil activity can be determined by measuring the amount of weed control of target weeds that emerge during a specific time period following herbicide application. In certain embodiments, an herbicide exhibits sufficient residual soil activity if the pre-emergent application of the typically recognized post-emergent herbicide provides a biomass reduction of 50% or greater, preferably 80% or greater, most preferably 90% or greater. Such reduction can be evaluated at a time of about 1 week, about 2 weeks, about 3 weeks, about 4 weeks, or even longer time periods. Preferably, a compound with residual soil activity provides the necessary percent of biomass reduction for a time of at least about 1 day, at least about 2 days, at least about 3 days, at least about 4 days, at least about 5 days, at least about 6 days, at least about one week, at least about two weeks, at least about three weeks, or at least about 4 weeks. Biomass reduction can be evaluated as a comparison of the number or mass of weeds that emerge and survive in a site treated with the test compound (I.e., the compound believed to have residual soil activity) and the number or mass of weeds that emerge and survive in a site not treated with the test compound. Preferably, evaluation is carried out so that weed seeds are expected to germinate and grow within a short time after application of the test compound (e.g., with 1 day, 2 days, or the like) so that an accurate evaluation of time of residual effect can be established.

One method of establishing the percentage of biomass reduction is to take weed counts or hand weed quadrates mapped in each plot, of a series of test plots, at the time of herbicidal application and various set times after herbicidal application to determine what weeds emerge after application and then what is controlled in the treated sites. Visual ratings or even destructive biomass measurements can be taken of the different weeds. For example, visual comparisons can be performed by comparing treated and untreated test sites. Further, hand harvesting and weighting of the remaining biomass should result in an equal measurement as one taken visually. For example, if flucarbazone is applied to a site and 7 days later weeds emerge in that site the residual soil activity for flucarbazone can be established at the time of 7 days after the pre-emergent application of flucarbazone due to frequent visits and visual comparisons at the test sites or by removing/counting weeds in the sites. Since any later emerging weeds (i.e., emerging after application of any herbicide) did not receive any foliar herbicide and are growing in the herbicide present in the soil, weed control can be attributed to the level of residual soil activity of the particular herbicide in question. Accordingly, any herbicide can be easily evaluated for possibly exhibiting residual soil activity and for how many days the herbicide exhibits a sufficient residual soil activity according to embodiments of the present invention.

Another way of establishing the percentage of biomass reduction is to apply a known non-residual herbicide to either a plot or as a strip along all the plots, of a series of test plots, to remove all target weeds at the time of application of the particular herbicide in question. At the time of each rating, weed control measurements are taken. As such, each measurement for residual weed control is a comparison of the site that received the treatment with the known non-residual herbicide and the sites that were treated with the particular herbicide in question to evaluate whether the particular herbicide in question exhibits residual soil activity and to what extent (e.g., does the herbicide in question exhibit sufficient control of later emerging weeds as discussed herein). Weeds that emerge after application of a particular herbicide in question will not have received any foliar herbicide and are therefore controlled by the residual herbicide (i.e., the particular herbicide in question if it exhibits residual soil activity). Further, other timings can be made with a non-residual herbicide to determine the length of time that weeds can emerge before they are no longer controlled by the residual herbicide (i.e., herbicide exhibiting residual soil activity).

One way of determining the number of days for which a particular herbicide exhibits sufficient residual soil activity includes the use of test plots in which weeds are seeded at different depths so that weeds emerge continuously over a desired period of time. Preferably, the environmental conditions (e.g., rainfall/water, and soil characteristics) of the test plots are controlled to mimic or emulate what is considered “normal” growing conditions for a certain soil zone (cropping area). Thus, knowing the application time of the herbicide in question and the time of weed emergence after herbicide application the residual weed control can then be mapped-out. Beneficially, the residual weed control can be determined for a variety of weeds.

Unwanted vegetation that can be controlled according to various embodiments of the present invention can include any type of vegetation typically amenable to control via application of a post-emergent herbicide. More particularly, the unwanted vegetation can include, but is not limited to, wild oat, volunteer oat, canarygrass, giant foxtail, Persian darnel, volunteer corn, green foxtail, annual ryegrass, Italian ryegrass, windgrass, cheat, Japanese brome, redroot pigweed, wild mustard, shepherd's purse, yellow foxtail, downy brome, barnyardgrass, redroot pigweed, volunteer canola, volunteer corn, stinkweed, green smartweed, and wild buckwheat.

### Pre-Emergent Application

Various chemical compounds typically recognized as post-emergent herbicides may be used for pre-emergent application according to the various embodiments of the present invention. Preferably, the post-emergent herbicides used in pre-emergent application according to the present invention exhibit certain preferable properties. For example, it is useful for the herbicidally active chemical compound or compounds in the post-emergent herbicides to exhibit a certain degree of residual soil activity. As known in the art, the typically recognized post-emergent herbicides used for pre-emergent application should preferably exhibit acceptable crop selectivity such that the desired crop is not damaged or killed.

Embodiments of the present invention utilize traditionally recognized post-emergent herbicides in a pre-emergent application. Suitable typically recognized post-emergent herbicides for pre-emergent treatment of a crop planting site according to embodiments of the present invention include compounds that exhibit sufficient residual soil activity to initiate the control and ultimate destruction of unwanted vegetation prior to the emergence thereof or prior to reaching a state of maturity. Suitable typically recognized post-emergent herbicides are also those that exhibit sufficient residual soil activity to substantially weaken any emerging unwanted vegetation so that later application of a post-emergent herbicide can be in an amount that is much less than traditionally required (e.g., less than an application rate listed on the herbicide label). Further, mixtures of typically recognized post-emergent herbicides can also be applied to a crop planting site as a pre-emergent treatment. In one preferred embodiment, the pre-emergent treatment comprises the application of the typically recognized post-emergent herbicide flucarbazone-sodium.

In one preferred embodiment, unwanted vegetation is controlled by a method comprising the pre-emergent application of flucarbazone-sodium and a later post-emergent application of flucarbazone-sodium. Since flucarbazone-sodium is also an acetolactate synthase inhibitor, flucarbazone-sodium controls weed bio-types that have developed resistance to certain classes of herbicides, including ACCase inhibitors, dinitroanilanes and triallates among others. Upon application, flucarbazone-sodium is absorbed by foliage and roots of the unwanted vegetation, which cease growth shortly thereafter. Additionally, the residual soil activity provided by flucarbazone-sodium also enables its use prior to the emergence of the unwanted vegetation. Consequently, flucarbazone-sodium is ideal for use as a pre-emergent application coupled with its more traditional use in a post-emergent application as a post-emergent herbicide. Flucarbazone-sodium is available commercially from Arysta LifeScience under the labels EVEREST® and PRE-PARE™. Preferably, unwanted vegetation is controlled by using flucarbazone or any salt thereof in a pre-emergent application in combination with applying any traditionally recognized post-emergent herbicide in a post-emergent application. The post-emergent application can be applied to the crop planting site as a whole of more specifically just to a locus of unwanted vegetation. In such embodiments, the total amount of herbicidally active compounds can be reduced by varying degrees.

In various embodiments, the pre-emergent treatment of a crop planting site comprises the application of at least an effective amount of a typically recognized post-emergent herbicide to the crop planting site. An effective amount of a typically recognized post-emergent herbicide comprises an amount needed such that a post-emergent application of the same or different traditionally recognized post-emergent herbicide to the crop planting site, or alternatively directly to the unwanted vegetation, is reduced relative to the amount of the post-emergent herbicide required for the control of unwanted vegetation in the absence of the pre-emergent treatment. For instance, post-emergent herbicides have commonly been applied to crop planting sites upon varying levels of crop emergence as the sole means for controlling unwanted vegetation. One such example includes the recommended application procedure for the post-emergent herbicide clodinafop-propargyl (available under the label DISCOVER®). The product label for DISCOVER® instructs users to apply clodinafop-propargyl from the 1-leaf stage to 6-leaf stage (i.e., actively growing weeds). Further, the recommended application rate for the control of wild oats, volunteer oats, green foxtail, yellow foxtail, barnyardgrass, canarygrass and volunteer corn is 3.2 ounces DISCOVER® per acre (56 grams of active ingredient per hectare). As an example, an effective amount of a triazolone herbicide (or alternatively an ALS inhibitor) when applied pre-emergent comprises an amount necessary for the control of unwanted vegetation by post-emergent application of DISCOVER® at a rate that is less than 3.2 ounces per acre (56 grams of active ingredient per hectare).

To further illustrate embodiments of the present invention, a typically recognized post-emergent herbicide can be applied in a pre-emergent fashion either (i) prior to the seeding of the desired crop (i.e., pre-plant), (ii) at some time after the seeding of the crop, but prior to the emergence of unwanted vegetation (i.e., post-plant), (iii) at a first time prior to the seeding of the crop (i.e., pre-plant) and again at a second time after seeding of the crop but prior the emergence of unwanted vegetation (i.e., post-plant), or (iv) at some time after emergence of some weeds but prior to emergence of the seeded crop. Pre-emergent application of a typically recognized post-emergent herbicide, such as flucarbazone, can effectively initiate the control and destruction of unwanted vegetation due its residual soil activity. As such, the amount of a post-emergent herbicide required to clean-up or finalize the destruction of unwanted vegetation in a post-emergent application is reduced. In certain embodiments, the overall amount of herbicidally active compounds necessary to control unwanted vegetation is less than the amount required when a commercially available post-emergent herbicide is used alone (i.e., no pre-emergent application of a typically recognized post-emergent herbicide).

Any typically recognized post-emergent herbicide exhibiting residual soil activity can be utilized in a pre-emergent application according to the present invention. Surprisingly, when such compounds are applied to a crop planting site in a pre-emergent fashion and a commercially available post-emergent herbicide is applied to the crop planting site and/or the unwanted vegetation after emergence thereof, unwanted vegetation is controlled at least as effectively as traditional application procedures and rates of post-emergent herbicides alone. More specifically, embodiments of the present invention comprising the application of a typically recognized post-emergent herbicide in a pre-emergent fashion followed by the application of a traditional or commercially available post-emergent herbicide, such as DISCOVER®, in a post-emergent treatment provide an effective level of control of unwanted vegetation in a crop planting site when compared to methods wherein a post-emergent herbicide, such as DISCOVER®, is applied only in a post-emergent treatment to a crop planting site having actively growing unwanted vegetation or alternatively to the actively growing unwanted vegetation.

In one alternative embodiment, the pre-emergent application of a typically recognized post-emergent herbicide can comprise a mixture of two or more typically recognized post-emergent herbicides. Similarly, the post-emergent application can comprise a mixture of two or more commercially available post-emergent herbicides. Further, the pre-emergent application and the post-emergent application can include adjuvants as is known in the art.

Application of the typically recognized post-emergent herbicide in a pre-emergent fashion and the subsequent post-emergent treatment can be carried out in the crop planting site according to conventional techniques. For example, water dispersible or water soluble herbicidally active substances can be dispersed or dissolved in water and sprayed onto a planting site. The herbicidally active formulations can be administered to the crop planting site via ground and aerial application procedures. Further, the pre-emergent application of a typically recognized post-emergent herbicide and the post-emergent application of any commercially available post-emergent herbicide can include adjuvants as is known in the art. More specifically, surfactants, wetting agents, dispersing agents, suspending agents, and/or emulsifying agents can be employed with the herbicidal compositions. Further, tank-mixes including the herbicidally active compound(s) and known adjuvants can also include other ingredients such as fertilizers and pesticides if desired so long as the addition of these items does not render the herbicidally active substance(s) ineffective for their intended purpose.

In specific embodiments, the typically recognized post-emergent herbicide used in a pre-emergent fashion, as described herein, can be selected from specific groups of compounds. In one embodiment, the typically recognized post-emergent herbicide used in a pre-emergent fashion comprises any herbicide having residual soil activity. In other embodiments, the typically recognized post-emergent herbicide used in a pre-emergent fashion comprises compounds selected from the group consisting of sulfonylamino-carbonyltriazolinone, triazolopyrimidines, and combinations thereof.

In still further embodiments, the typically recognized post-emergent herbicide used in a pre-emergent fashion comprises compounds recognized as having specific activities. For example, the typically recognized post-emergent herbicide can comprise an ALS inhibitor. ALS inhibitors are herbicides that inhibit the enzyme acetolactate synthase (ALS), also known as acetohydroxy acid synthase (AHAS), which catalyses the first reaction of the biosynthetic sequence leading to the branched chain amino acids valine, leucine and isoleucine. Within a few hours, this inhibited synthesis of the branched chain amino acids leads to a secondary inhibition of DNA synthesis and a rapid cessation of plant growth. In actual use, application of an ALS inhibitor to plants that are sensitive to ALS inhibitors results in stoppage of plant growth, occasional change in plant color (e.g., taking on a red hue arising from synthesized stress anthocyanins), plant withering, and eventual plant death. For illustration, a non-exhaustive list of suitable ALS inhibitors in accordance with embodiments of the present invention include the following (which also provides exemplary commercial products incorporating the noted active compounds): imazamethabenz (ASSERT®), sulfosulfuron (MAVERICK®), flucarbazone (EVEREST®), propoxycarbazone (e.g., propoxycarbazone-sodium commercially available as OLYMPUS™), metsulfuron (ALLY®), triasulfuron (AMBER®), metsulfuron+tribenuron+thifensulfuron (CANVASS®), tribenuron (EXPRESS®), metsulfuron+chlorsulfuron (FINESSE®), chlorsulfuron (GLEAN®), thifensulfuron (HARMONY®), tribenuron+thifensulfuron (HARMONY EXTRA®), prosulfuron (PEAK®), imazapic (PLATEAU®), imazathapyr (PURSUIT®), and imazamox (RAPTOR®).

ALS inhibitors are commonly recognized as being Group 2 herbicides. As such, embodiments of the present invention can include the pre-emergent application of a Group 2 herbicide. Exemplary Group 2 herbicides in accordance with embodiments of the present invention include, but are not limited to, the following: imidazolinones, pyrimidinylthio-benzoates, sulfonylamino-carbonyltriazolinones, sulfonylureas, and triazolopyrimidines.

Examples of imidazolinones include imazamethabenz, imazamox, imazapic, imazapyr, imazaquin, and imazethapyr.

Examples of pyrimidinylthio-benzoates include bispyribac-sodium, pyrithiobac, and pyribenzoxim.

Examples of sulfonylamino-carbonyltriazolinones include flucarbazone-sodium, propoxycarbazone, and thiencarbazone.

Examples of sulfonylureas include amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron-methyl-sodium, foramsulfuron, halosulfuron, iodosulfuron, mesosulfuron, metsulfuron, nicosulfuron, primisulfuron, prosulfuron, pyrazosulfuron-ethyl, rimsulfuron, sulfometuron, sulfosulfuron, thifensulfuron, triasulfuron, tribenuron, trifloxysulfuron sodium, and triflusulfuron.

Examples of triazolopyrimidines include cloransulam-methyl, diclosulam, florasulam, flumetsulam, and pyroxsulam.

Further, in other embodiments the typically recognized post-emergent herbicide used in a pre-emergent fashion comprises compounds recognized as Acetyl coenzyme A carboxylase (ACCase) inhibitors. Acetyl coenzyme A carboxylase (ACCase) is necessary for the first step of lipid synthesis. Thus, ACCase inhibitors affect cell membrane production in the meristems of plants. By way of example, a non-exhaustive list of suitable ACCase inhibitors in accordance with embodiments of the present invention include the following: tralkoxydim (ACHIEVE®), quizalofop (ASSURE II®), diclofop (HOELON®), clodinafop (HORIZON®/DISCOVER®), sethoxydim (POAST®), fenoxyprop (PUMA®), clethodim (SELECT®).

In yet further embodiments, specific compounds typically recognized as having post-emergent activity can be used for pre-emergent application according to the present invention. For example, the typically recognized post-emergent herbicide applied in a pre-emergent fashion can be selected from the group consisting of flucarbazone, propoxycarbazone, thiencarbazone, saflufenacil, KIH-485, and pyroxsulam.

In one embodiment, the typically recognized post-emergent herbicide applied in a pre-emergent fashion comprises saflufenacil (KIXOR™). Saflufenacil is a pyrimidinedione PPO inhibitor. In another embodiment, the typically recognized post-emergent herbicide applied in a pre-emergent fashion comprises KIH-485 available from K-I Chmeical USA, Inc. (White Plains, N.Y.).

As referenced above, alternative embodiments can include the pre-emergent application of a typically recognized post-emergent herbicide and can comprise the application of a mixture of two or more typically recognized post-emergent herbicides. For instance one or more ALS inhibitors or Group 2 herbicides typically recognized as post-emergent herbicides can be tank-mixed and applied in a pre-emergent fashion. Similarly, two or more ACCase inhibitors typically recognized as a post-emergent herbicide can be tank-mixed and applied in a pre-emergent fashion. In one embodiment, one or more ALS inhibitor and one or more ACCase inhibitor is tank-mixed and applied to the soil of a crop planting site in a pre-emergent fashion. As such, certain embodiments of the present invention include the co-application of more than one of the previously described herbicides typically recognized as a post-emergent herbicide suitable for application in a pre-emergent fashion.

In addition to the application of tank-mixes having more than one typically recognized post-emergent herbicide, various alternative embodiments include the application of a tank-mix including one or more of the previously described herbicides that are typically recognized as a post-emergent herbicide and one or more typically recognized pre-emergent herbicides. For example, in certain embodiments, a typically recognized post-emergent herbicide suitable for use in a pre-emergent fashion can be tank mixed with a variety of pre-emergent herbicides including, but not limited to, metsulfuron, triasulfuron, prosulfuron, sulfosulfuron, and ethoxysulfuron.

Additional alternative embodiments according to the present invention include the co-application of one or more of the previously described herbicides that are typically recognized as a post-emergent herbicide and various other herbicides. In some embodiments, one or more typically recognized post-emergent herbicide as described as being suitable for application in a pre-emergent fashion can be tank-mixed with traditional pre-emergent herbicides and/or other typically recognized post-emergent herbicides. For instance, flucarbazone, propoxycarbazone, thiencarbazone, saflufenacil, KIH-485, or pyroxsulam (to name but a few) can be tank mixed not only with one or more ALS inhibitor (Group 2 herbicide) or ACCase inhibitor (Group 1 herbicide), but also with other post-emergent herbicides. For example, flucarbazone, propoxycarbazone, thiencarbazone, saflufenacil, KIH-485, or pyroxsulam (to name but a few) can be tank mixed any of the following types of post-emergent herbicides, according to embodiments of the present invention, cyclohexanediones (e.g., clethodim, sethoxydim, tepraloxydim), phenoxy herbicides (e.g., 2,4-D, MCPA, dichlorprop), benzoic acids (e.g., dicamba), carboxylic acids (e.g., fluoroxypyr, and clopyralid), quinaline carboxylic acids (e.g., quinclorac), triazolinones (e.g., amicarbazone), triazinones (e.g., sulfentrazone, carfentrazone), phenylpyrazoles (e.g., pyraflufen), pyrazoles (e.g., pyrasulfotole), isoxazolidinones (e.g., clomazone), diphenylethers (e.g., lactofen), pyridinecarboxamides (e.g., picolinafen), pyrazoles (e.g., rice herbicides such as benzofenap, pyrazolynate, and pyrazoxyfen), isoxazoles (e.g., isoxaflutole), inhibitors of protoporphyrinogen such as azafenidin, and flufenpyr. In one alternative embodiment, the present invention includes the co-application of one or more typically recognized post-emergent herbicide suitable for application in a pre-emergent fashion according to embodiments of the present invention and compounds that are inhibitors of long chain fatty acids such as the chloroacetamides.

In one embodiment, the present invention includes the co-application of one or more of the previously described herbicides that are typically recognized as a post-emergent herbicide and organophosphorus-based herbicides. Examples of organophosphorus-based herbicides include amiprofos-methyl, anilofos, bensulide, bilanafos, butamifos, 2,4-DEP, DMPA, EBEP, fosamine, glufosinate, glyphosate, and piperophos. In one particular embodiment flucarbazone is tank-mixed with glyphosate and applied to a crop planting site prior to the emergence of the desired crop. This is an example of using a broad spectrum herbicide (i.e., glyphosate) to kill any existing, emerged weeds at the planting site and using a post-emergent herbicide with residual soil activity (i.e., flucarbazone) to achieve the reduced rate of application of a post-emergent herbicide at a later time after further weed emergence (if any occurs in light of the application of the post-emergent herbicide with residual soil activity).

As used herein, the term “co-application” includes the application of one or more typically recognized post-emergent herbicides suitable for application in a pre-emergent fashion concurrently, sequentially, or alternately with any of the compounds described herein. Concurrent co-application refers to the application of more than one herbicidally active compound in a pre-emergent fashion at essentially the same time (which can mean within a 24 hour time period, within a 12 hour time period, within an 8 hour time period, within a 4 hour time period, within a 2 hour time period, within a 1 hour time period, or simultaneously, such as being co-mixed).

### Post-Emergent Application

A wide variety of post-emergent herbicides are suitable for application to crop planting sites in a post-emergent fashion according to embodiments of the present invention. Although any commercially available post-emergent herbicide is contemplated in embodiments of the present invention, exemplary post-emergent herbicides for application in a post-emergent fashion in accordance with embodiments of the present invention include, but are not limited to, the following: amides, arylaminopropionic acids, aryloxyphenoxy-propionates (“fops”), benzofurans, benzoic acids, benzothiadiazole, bipyridyliums, carbamates, cyclohexanediones (“dims”), dinitrophenols, diphenyl ethers, glycines, imidazolinones, nitriles, N-phenylphthalimides, organoarsenicals, organophosphorus, phenoxyalkanoic acids, phenyl carbamates, phenylpyrazolines, ureas, phenyureas, phosphinic acids, pyridine carboxylic acids, pyrimidinyl thiobenzoates, quinoline carboxylic acids, sulfonylamino-carbonyltriazolinones, sulfonylureas, thiadiazoles, triazoles, triazolones, triazolopyrimidines, and triketones.

Examples of amide herbicides include allidochlor, beflubutamid, benzadox, benzipram, bromobutide, cafenstrole, CDEA, cyprazole, dimethenamid, diphenamide, epronaz, etnipromid, fentrazamide, flupoxam, fomesafen, halosafen, isocarbamid, isoxaben, napropamide, naptalam, pethoxamide, propyzamide, saflufenacil and tebutam.

Examples of carbamate herbicides include asulam, carboxazole, chlorprocarb, dischlormate, fenasulam, karbutilate and terbucarb.

Examples of dinitrophenol herbicides include dinofenate, dinoprop, dinosam, dinaoseb, dinoterb, DNOC, etinofen and medinoterb.

Examples of diphenyl ether herbicides include ethoxyfen, acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen.

Examples of imidazolinone herbicides include imazamethabenz, imazamox, imazapic, imazapyr, imazaquin and imazethapyr.

Examples of nitrile herbicides include bromobonil, bromoxynil, chloroxynil, dichlobenil, iodobonil, ioxynil and pyraclonil.

Examples of organophosphorus-based herbicides include amiprofos-methyl, anilofos, bensulide, bilanafos, butamifos, 2,4-DEP, DMPA, EBEP, fosamine, glufosinate, glyphosate, and piperophos.

Examples of phenoxy herbicides include bromofenoxim, clomeprop, 2,4-DEB, 2,4-DEP, difenopenten, disul, erbon, etnipromid, fenteracol and trifopsime. Additional examples include phenoxyacetic herbicides, phenoxybutyric herbicides, phenoxypropionic herbicides and aryloxyphenoxypropionic herbicides, which include chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop.

Examples of pyridine herbicides include aminopyralid, cliodinate, clopyralid, dithiopyr, fluoroxypyr, haloxydine, picloram, picolinafen, pyriclor, pyroxsulam, thiazopyr and triclopyr.

Examples of triazinone herbicides include ametridione, amibuzin, hexazinone, isomethiozin, metamitron and metribuzin.

Examples of triazole herbicides include amitrole, cafenstrole, epronaz and flupoxam.

Examples of triazolopyrimidine herbicides include cloransulam, diclosulam, florasulam, flumetsulam, metosulam, penoxsulam and pyroxsulam.

Examples of phenylurea herbicides include anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron and thidiazuron.

Examples of sulfonylaminocarbonyltriazolinone herbicides include flucarbazone, propoxycarbazone, and thiencarbazone.

Examples of sulfonylurea herbicides include amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, inazosulfuron, mesosulfuron, nicosulfuron, orthosulfamuron, oxasulfuron, primisulfuron, pyrazosulfuron, rimsulfuron, sulfometuron, sulfosulfuron, trifloxysulfuron, chlorsulfuron, cinosulfuron, ethametsulfuron, iodosulfuron, metsulfuron, prosulfuron, thifensulfuron, triasulfuron, tribenuron, triflusulfuron, tritosulfuron, buthiuron, ethidimuron, tebuthiuron, thiazafluoron and thidiazuron.

Examples of triazolone herbicides include amicarbazone, bencarbazone, carfentrazone, and sulfentrazone.

An example of a phenylpyrazoline includes pinoxaden.

### Application Rates

Typically recognized post-emergent herbicides are generally labeled with a recommended application rate, which can be described as the post-emergent application rate. One such example includes the recommended post-emergent application procedure for flucarbazone-sodium (EVEREST®). The EVEREST® product label instructs users to apply flucarbazone-sodium to spring wheat prior to jointing, when the majority of plants have from one leaf to a maximum of 4 leaves on the main stem plus two tillers. Further, for winter wheat, the label recommends applying the product when the majority of plants have one leaf to full tillering, but prior to jointing. The full application rate is 0.6 ounces per acre (30 grams of active ingredient per hectare).

In certain embodiments, a typically recognized post-emergent herbicide, as described herein, is applied to a crop planting site in a pre-emergent fashion in an amount less than typically recommended when applied as a post-emergent. In various embodiments the pre-emergent application of a typically recognized post-emergent herbicide comprises from about 10% to about 85% of the recommended amount or rate when applied as a post-emergent, preferably from about 25% to about 75%, more preferably from about 40% to about 60% of the recommended amount or rate when applied as a post-emergent. For example, a typically recognized post-emergent herbicide having a label-recommended application rate of 0.6 ounces per acre could be applied in a pre-emergent fashion in an amount of about 0.06 to about 0.51 ounces per acre.

According to further embodiments of the present invention, the total amount of post-emergent herbicide (i.e., the amount applied in a pre-emergent fashion plus the amount applied in a post-emergent fashion) applied to the crop planting site and/or a locus of unwanted vegetation necessary for controlling the unwanted vegetation is no more than 75% of the amount of post-emergent herbicide recommended for post-emergent use alone with the crop. According to other embodiments of the present invention, the total amount of post-emergent herbicide applied to the crop planting site and/or a locus of unwanted vegetation necessary for controlling the unwanted vegetation is reduced by about 12% to about 75% or by about 25% to about 75% from the amount typically administered as a post-emergent treatment alone.

In another embodiment, the amount of post-emergent herbicide used in the post-emergent application is reduced by about 25% to about 65%. In yet another embodiment, the amount of post-emergent herbicide used in the post-emergent application is reduced by about 25% to about 50%. In one alternative embodiment, the necessary amount of post-emergent herbicide applied in the post-emergent application is reduced by about 60% to about 40%. For example, a typically recognized post-emergent herbicide having a label-recommended post-emergent application rate of 0.6 ounces per acre could be applied post-emergent, according to methods of the present invention, in an amount reduced by 0.15 ounces per acre to as much as 0.39 ounces per acre. In other words, the post-emergent application rate would be about 0.21 to about 0.45 ounces per acre instead of the recommended 0.6 ounces per acre.

In one embodiment, less than 0.6 ounces per acre of flucarbazone-sodium (30 grams of active ingredient per hectare), or similar herbicide, is applied in a pre-emergent fashion to a crop planting site. In various embodiments, the amount of flucarbazone-sodium, or similar herbicide, applied in a pre-emergent fashion can comprise from between 0.1 to 0.5 ounces per acre (about 5 to 25 grams of active ingredient per hectare) or from between 0.2 to 0.45 ounces per acre (about 10 to 22.5 grams of active ingredient per hectare). In other alternative embodiments, the amount of flucarbazone-sodium applied in a pre-emergent fashion can comprise from between 0.25 to 0.4 ounces per acre (about 12.5 to 20 grams of active ingredient per hectare), or alternatively between about 0.45 to about 0.55 ounces per acre (about 22.5 to 27.5 grams of active ingredient per hectare). Due to the residual activity of flucarbazone-sodium in the soil, the amount of herbicidally active compounds necessary for post-emergent application is reduced.

In certain embodiments, the amount of post-emergent herbicide applied in a post-emergent application to the crop planting site and/or the locus of unwanted vegetation necessary for controlling the unwanted vegetation is reduced by about 25% to about 75% of the amount typically administered as a post-emergent. In another embodiment, the amount of post-emergent herbicide applied in a post-emergent fashion is reduced by about 25% to about 65%. In yet another embodiment, the amount of post-emergent herbicide applied in a post-emergent fashion is reduced by about 25% to about 50%. In one preferred embodiment, the necessary amount of post-emergent herbicide applied in a post-emergent fashion is reduced by about 60% to about 40%. In one alternative embodiment, the necessary amount of post-emergent herbicide applied in a post-emergent fashion is reduced by about 70% to about 80% while in another embodiment the necessary amount of post-emergent herbicide applied in a post-emergent fashion is reduced by about 85% to about 90%.

In other embodiments, the total amount of herbicidally active compounds (e.g., active ingredient) to control or prevent unwanted vegetation can be reduced by applying a traditionally recognized post-emergent herbicide that exhibits residual soil activity, such as a flucarbazone, propoxycarbazone, thiencarbazone, or pyroxsulam, to a crop planting site in a pre-emergent fashion followed by the application of the same or different herbicidally active substance in a post-emergent application.

### EXAMPLES

### Example 1

A study was conducted to test various application methods using flucarbazone-sodium (EVEREST®) in a pre-emergent application followed by post-emergent application with either clodinafop-propargyl (DISCOVER®) or Everest®. The results of the study are illustrated in Table 1.

To better evaluate the ability of each treatment scheme in controlling unwanted vegetation in a planting site, a group of nearly identical crop planting sites (Site 1-Site 15) were subjected to different treatment schemes. Site No. 1 was untreated to act as a control site. Site No. 2-Site No. 4 were treated only pre-emergent. Site No. 5-Site No. 14 were treated both pre-emergent and post-emergent. Site No. 15 was treated only post emergent. Treatment rate was based on the recommended rate provided on the product label (grams of active ingredient per hectare). Since the label provided a range, the rate is based on the low end of the recommended rate from the label range. In the untreated site (Site No. 1), weeds sprouted and grew to cover the site. Thus, Site No. 1 showed 0% weed control. The remaining sites were allowed the same amount of time for weed growth and were visually compared to an untreated crop planting site (Site No. 1). The percent control of both Wild Oat and Green Foxtail was observed as a comparison to Site No. 1. Thus, percent control for Wild Oat and Green Foxtail was evaluated as the weed-free area in the particular site in comparison to the completely weed covered Site No. 1. Further, the respective crop yield for each crop planting site was also recorded.

TABLE 1

| Site | Treatment Scheme and application rate | % Control of | Crop Yield | % Control of |
|---|---|---|---|---|
| No. | in grams of active per hectare | Wild Oat | (Bu./Acre) | Green Foxtail |
| 1 | Untreated | 0 | 13.7 | 0 |
| 2 | Everest (Pre-Emergent): 10 gai/ha | 63 | 21.6 | 90 |
| 3 | Everest (Pre-Emergent): 15 gai/ha | 77 | 23.7 | 93 |
| 4 | Everest (Pre-Emergent): 20 gai/ha | 83 | 19.7 | 94 |
| 5 | Everest (Pre-Emergent): 10 gai/ha; and | 88 | 20.8 | 95 |
| | Discover (Post-Emergent): 28 gai/ha | | | |
| | (½ rate) | | | |
| 6 | Everest (Pre-Emergent): 15 gai/ha; and | 95 | 23.6 | 95 |
| | Discover (Post-Emergent): 28 gai/ha | | | |
| | (½ rate) | | | |
| 7 | Everest (Pre-Emergent): 20 gai/ha; and | 98 | 20.9 | 95 |
| | Discover (Post-Emergent): 28 gai/ha | | | |
| | (½ rate) | | | |
| 8 | Everest (Pre-Emergent): 10 gai/ha; and | 83 | 21.3 | 94 |
| | Discover (Post-Emergent): 14 gai/ha | | | |
| | (¼ rate) | | | |
| 9 | Everest (Pre-Emergent): 15 gai/ha; and | 99 | 22.3 | 95 |
| | Discover (Post-Emergent): 14 gai/ha | | | |
| | (¼ rate) | | | |
| 10 | Everest (Pre-Emergent): 20 gai/ha; and | 98 | 22 | 95 |
| | Discover (Post-Emergent): 14 gai/ha | | | |
| | (¼ rate) | | | |
| 11 | Everest (Pre-Emergent): 10 gai/ha; and | 77 | 21 | 95 |
| | Discover (Post-Emergent): 7 gai/ha | | | |
| | (⅛ rate) | | | |
| 12 | Everest (Pre-Emergent): 15 gai/ha; and | 90 | 23.1 | 95 |
| | Discover (Post-Emergent): 7 gai/ha (1/8 | | | |
| | rate) | | | |
| 13 | Everest (Pre-Emergent): 20 gai/ha; and | 100 | 23.8 | 94 |
| | Discover (Post-Emergent): 7 gai/ha (1/8 | | | |
| | rate) | | | |
| 14 | Everest (Pre-Emergent): 15 gai/ha; and | 100 | 24 | 95 |
| | Everest (Post-Emergent): 15 gai/ha | | | |
| 15 | Discover (Post-Emergent): 56 gai/ha | 84 | 18.1 | 95 |
| | (1× rate) | | | |

As illustrated by Table 1, unwanted vegetation consumed the entire untreated planting site (Site No. 1). As such, 0% of Site No. 1 exhibited a control of the unwanted vegetation and the crop yield was only 13.7 bushels per acre. The traditional treatment scheme was represented by Site No. 15. Specifically, Site No. 15 was not provided with any pre-emergent treatment. Instead, a full post-emergent rate application of DISCOVER® was provided to Site No. 15 in a post-emergent application. As illustrated in Table 1, 84% of the planting site was controlled with respect to Wild Oat and 95% of the planting site was controlled with respect to Green Foxtail. Further, Site No. 15 provided 18.1 bushels per acre.

Table 1 illustrates that methods according to embodiments of the present invention can provide control of unwanted vegetation at least as well as, and in some cases superior to, traditional methods of controlling unwanted vegetation through full rate post-emergent application of a post-emergent herbicide. Also illustrated by Table 1, embodiments according to the present invention can provide an increase in the yield of a desired crop. For example, Site No. 9 produced 22.3 bushels per acre as compared to 18.1 bushels per acre produced by Site No. 15. Further, the results illustrate the significant reduction in the post-emergent application amount of herbicidally active ingredients necessary for control of unwanted vegetation. For instance, the post-emergent application of clodinafop-propargyl can range from about 7 to about 28 grams of active per hectare, 7 to about 14 grams of active per hectare, or alternatively from about 14 to about 28 grams of active per hectare.

Additionally, the total amount of herbicidally active ingredient, according to certain embodiments of the present invention, can be less than the amount of active ingredient necessary to achieve similar results through the traditionally recommended approach for controlling unwanted vegetation by treating a planting site with a post-emergent treatment alone. For example, only 29 grams of active per hectare (i.e., 15 grams of active per hectare of EVEREST® plus 14 grams of active per hectare of DISCOVER®) were used to control the unwanted vegetation in Site No. 9 as compared to the 56 grams of active per hectare used in Site No. 15. Accordingly, the total amount of active ingredient used, according to this particular embodiment, was practically half the amount required by the traditionally recommended method.

### Example 2

A study was conducted to test various application methods using flucarbazone-sodium (EVEREST®) in a pre-emergent application followed by post-emergent application with pinoxaden (AXIAL™). AXIAL™ is a well known post-emergent herbicide. The results of the study are illustrated in Table 2.

To better evaluate the ability of each treatment scheme in controlling unwanted vegetation in a planting site, a group of nearly identical crop planting sites (Site 1-site 15) were subjected to different treatment schemes. Site No. 1 was untreated to act as a control site. Site No. 2-Site No. 4 were treated only pre-emergent. Site No. 5-Site No. 14 were treated both pre-emergent and post-emergent. Site No. 15 was treated only post emergent. Treatment rate was based on the recommended rate provided on the product label (grams of active ingredient per hectare). In the untreated site (Site No. 1), weeds sprouted and grew to cover the site. Thus, Site No. 1 showed 0% weed control. The remaining sites were allowed the same amount of time for weed growth and were visually compared to an untreated crop planting site (Site No. 1). The percent control of Wild Oat was observed as a comparison to Site No. 1. Thus, percent control for Wild Oat was evaluated as the weed-free area in the particular site in comparison to the completely weed covered Site No. 1. Further, the respective crop yield for each crop planting site was also recorded.

As referenced in Table 2, Basic Blend is a commercially available product commonly used in herbicidal applications. Basic Blend adjuvants contain different components that have different functions within the composition of the adjuvant, such as increasing water pH to increase water solubility of certain herbicides. Tank-mixes for post-emergent application included Adigor and Crop Oil Concentrate (COC). Adigor is an emulsifiable concentrate containing 47% w/w methylated rapeseed oil. COC is typically a petroleum or vegetable oil based product used to reduce the surface tension of water.

TABLE 2

| | | | | % Control of Wild | |
|---|---|---|---|---|---|
| Site | Treatment Scheme and application rate | | | Oat at 69 days after | Crop Yield |
| No. | in grams of active per hectare | | | application | (Bu./Acre) |
| 1 | Untreated | | | 0 | 41 |
| 2 | Pre-emergent | | | 75 | 52.8 |
| | Everest: | 10 | gai/ha | | |
| | Basic Blend: | 1% | v/v | | |
| 3 | Pre-emergent | | | 76.7 | 51.6 |
| | Everest: | 15 | gai/ha | | |
| | Basic Blend: | 1% | v/v | | |
| 4 | Pre-emergent | | | 83.3 | 79.7 |
| | Everest: | 20 | gai/ha | | |
| | Basic Blend: | 1% | v/v | | |
| 5 | Pre-emergent | | | 98 | 54.3 |
| | Everest: | 10 | gai/ha | | |
| | Basic Blend: | 1% | v/v | | |
| | Post-emergent | | | | |
| | Axial: | 30 | gai/ha (½ rate) | | |
| | Adigor: | 0.375% | v/v | | |
| | COC: | 1% | v/v | | |
| 6 | Pre-emergent | | | 97.3 | 52.3 |
| | Everest: | 15 | gai/ha | | |
| | Basic Blend: | 1% | v/v | | |
| | Post-emergent | | | | |
| | Axial: | 30 | gai/ha (½ rate) | | |
| | Adigor: | 0.375% | v/v | | |
| | COC: | 1% | v/v | | |
| 7 | Pre-emergent | | | 99 | 47.2 |
| | Everest: | 20 | gai/ha | | |
| | Basic Blend: | 1% | v/v | | |
| | Post-emergent | | | | |
| | Axial: | 30 | gai/ha (½ rate) | | |
| | Adigor: | 0.375% | v/v | | |
| | COC: | 1% | v/v | | |
| 8 | Pre-emergent | | | 93.3 | 52.5 |
| | Everest: | 10 | gai/ha | | |
| | Basic Blend: | 1% | v/v | | |
| | Post-emergent | | | | |
| | Axial: | 15 | gai/ha (¼ rate) | | |
| | Adigor: | 0.188% | v/v | | |
| | COC: | 1% | v/v | | |
| 9 | Pre-emergent | | | 97.7 | 50.1 |
| | Everest: | 15 | gai/ha | | |
| | Basic Blend: | 1% | v/v | | |
| | Post-emergent | | | | |
| | Axial: | 15 | gai/ha (¼ rate) | | |
| | Adigor: | 0.188% | v/v | | |
| | COC: | 1% | v/v | | |
| 10 | Pre-emergent | | | 94 | 53.3 |
| | Everest: | 20 | gai/ha | | |
| | Basic Blend: | 1% | v/v | | |
| | Post-emergent | | | | |
| | Axial: | 15 | gai/ha (¼ rate) | | |
| | Adigor: | 0.188% | v/v | | |
| | COC: | 1% | v/v | | |
| 11 | Pre-emergent | | | 87 | 55.5 |
| | Everest: | 10 | gai/ha | | |
| | Basic Blend: | 1% | v/v | | |
| | Post-emergent | | | | |
| | Axial: | 7.5 | gai/ha (⅛ rate) | | |
| | Adigor: | 0.094% | v/v | | |
| | COC: | 1% | v/v | | |
| 12 | Pre-emergent | | | 88.3 | 53.1 |
| | Everest: | 15 | gai/ha | | |
| | Basic Blend: | 1% | v/v | | |
| | Post-emergent | | | | |
| | Axial: | 7.5 | gai/ha (⅛ rate) | | |
| | Adigor: | 0.094% | v/v | | |
| | COC: | 1% | v/v | | |
| 13 | Pre-emergent | | | 94.3 | 52.3 |
| | Everest: | 20 | gai/ha | | |
| | Basic Blend: | 1% | v/v | | |
| | Post-emergent | | | | |
| | Axial: | 7.5 | gai/ha (⅛ rate) | | |
| | Adigor: | 0.094% | v/v | | |
| | COC: | 1% | v/v | | |
| 14 | Pre-emergent | | | 96.3 | 45.2 |
| | Everest: | 15 | gai/ha | | |
| | Basic Blend: | 1% | v/v | | |
| | Post-emergent | | | | |
| | Everest: | 15 | gai/ha | | |
| | Basic Blend: | 1% | v/v | | |
| 15 | Post-emergent | | 99 | 57.4 | |
| | Axial: | 60 | gai/ha (full rate) | | |
| | Adigor: | 0.75% | v/v | | |

Table 2 illustrates that methods according to embodiments of the present invention can provide control of unwanted vegetation at least as well as, and in some cases superior to, traditional methods of controlling unwanted vegetation through full rate post-emergent application of a post-emergent herbicide. These results illustrate the significant reduction in the post-emergent application amount of herbicidally active ingredients necessary for control of unwanted vegetation. For instance, the post-emergent application of pinoxaden can range from about 7.5 to about 30 grams of active per hectare, 7.5 to about 15 grams of active per hectare, or alternatively from about 15 to about 30 grams of active per hectare.

Moreover, the total amount of herbicidally active ingredient, according to certain embodiments of the present invention, can be less than the amount of active ingredient necessary to achieve similar results through the traditionally recommended approach for controlling unwanted vegetation by treating a planting site with a post-emergent treatment alone. For example, only 30 grams of active per hectare (i.e., 15 grams of active per hectare of EVEREST® plus 15 grams of active per hectare of AXIAL™) were used to control the unwanted vegetation in Site No. 9 as compared to the 60 grams of active ingredient used in Site No. 15. As yet another example, only 40 grams of active ingredient (i.e., 10 grams of active per hectare of EVEREST® plus 30 grams of active per hectare of AXIAL™) were used to control the unwanted vegetation in Site No. 5 as compared to the 60 grams of active per hectare used in Site No. 15. Furthermore, despite utilizing a total reduced amount of herbicidally active, the percent control of unwanted vegetation in Site No. 5 was strikingly similar to that illustrated in Site No. 15. Accordingly, the total amount of active ingredient used, according to this particular embodiment, was about 66% of the total amount of active ingredient required by the traditionally recommended method.

### Example 3

A study similar to those presented in Examples 1 and 2 was conducted to test various application methods using flucarbazone-sodium (EVEREST®) in a pre-emergent application followed by post-emergent application with clodinafop (HORIZON®). The results of the study are illustrated in Table 3.

To better evaluate the ability of each treatment scheme in controlling unwanted vegetation in a planting site, a group of nearly identical crop planting sites (Site 1-Site 15) were subjected to different treatment schemes. Site No. 1 was untreated to act as a control site. Site No. 2-Site No. 4 were treated only pre-emergent. Site No. 5-Site No. 14 were treated both pre-emergent and post-emergent. Site No. 15 was treated only post emergent. Treatment rate was based on the recommended rate provided on the product label (grams of active ingredient per hectare). In the untreated site (Site No. 1), weeds sprouted and grew to cover the site. Thus, Site No. 1 showed 0% weed control. The remaining sites were allowed the same amount of time for weed growth and were visually compared to an untreated crop planting site (Site No. 1). The percent control of Wild Oat was observed as a comparison to Site No. 1. Thus, percent control for Wild Oat was evaluated as the weed-free area in the particular site in comparison to the completely weed covered Site No. 1. In addition to EVEREST®, tank-mixes for pre-emergent application included Pro-Surf. Pro-Surf is a non-ionic surfactant made up of 90% alkylarylpolyoxyethylene glycols and free fatty acids to reduce the surface tension of spray droplets. Pro-Surf is marketed by Norac Concepts Inc. [Ontario, Canada]. Tank-mixes for post-emergent application of HORIZON® included SCORE®, which is a liquid spray tank adjuvant comprising an emulsifiable oil product. SCORES includes a blend of surfactant and an agricultural spray oil for use with HORIZON® Herbicide products.

TABLE 3

| | | | | % Control of Wild |
|---|---|---|---|---|
| | | | | Oat at 33 days after |
| Site | Treatment Scheme and application rate in | | | the post-emergent |
| No. | grams of active per hectare | | | application |
| 1 | Untreated | | | 0 |
| 2 | Pre-emergent | | | 76.3 |
| | Everest: | 10 | gai/ha | |
| | Pro Surf: | 0.25% | v/v | |
| 3 | Pre-emergent | | | 86.3 |
| | Everest: | 15 | gai/ha | |
| | Pro Surf: | 0.25% | v/v | |
| 4 | Pre-emergent | | | 83.8 |
| | Everest: | 20 | gai/ha | |
| | Pro Surf: | 0.25% | v/v | |
| 5 | Pre-emergent | | | 93.8 |
| | Everest: | 10 | gai/ha | |
| | Pro Surf: | 0.25% | v/v | |
| | Post-emergent | | | |
| | Horizon: | 28 | gai/ha (½ rate) | |
| | Score: | 0.8% | v/v | |
| 6 | Pre-emergent | | | 95 |
| | Everest: | 15 | gai/ha | |
| | Pro Surf: | 0.25% | v/v | |
| | Post-emergent | | | |
| | Horizon: | 28 | gai/ha (½ rate) | |
| | Score: | 0.8% | v/v | |
| 7 | Pre-emergent | | | 93.8 |
| | Everest: | 20 | gai/ha | |
| | Pro Surf: | 0.25% | v/v | |
| | Post-emergent | | | |
| | Horizon: | 28 | gai/ha (½ rate) | |
| | Score: | 0.8% | v/v | |
| 8 | Pre-emergent | | | 95 |
| | Everest: | 10 | gai/ha | |
| | Pro Surf: | 0.25% | v/v | |
| | Post-emergent | | | |
| | Horizon: | 14 | gai/ha (¼ rate) | |
| | Score: | 0.8% | v/v | |
| 9 | Pre-emergent | | | 93.3 |
| | Everest: | 15 | gai/ha | |
| | Pro Surf: | 0.25% | v/v | |
| | Post-emergent | | | |
| | Horizon: | 14 | gai/ha (¼ rate) | |
| | Score: | 0.8% | v/v | |
| 10 | Pre-emergent | | | 95 |
| | Everest: | 20 | gai/ha | |
| | Pro Surf: | 0.25% | v/v | |
| | Post-emergent | | | |
| | Horizon: | 14 | gai/ha (¼ rate) | |
| | Score: | 0.8% | v/v | |
| 11 | Pre-emergent | | | 90 |
| | Everest: | 10 | gai/ha | |
| | Pro Surf: | 0.25% | v/v | |
| | Post-emergent | | | |
| | Horizon: | 7 | gai/ha (⅛ rate) | |
| | Score: | 0.8% | v/v | |
| 12 | Pre-emergent | | | 86.3 |
| | Everest: | 15 | gai/ha | |
| | Pro Surf: | 0.25% | v/v | |
| | Post-emergent | | | |
| | Horizon: | 7 | gai/ha (⅛ rate) | |
| | Score: | 0.8% | v/v | |
| 13 | Pre-emergent | | | 85 |
| | Everest: | 20 | gai/ha | |
| | Pro Surf: | 0.25% | v/v | |
| | Post-emergent | | | |
| | Horizon: | 7 | gai/ha (⅛ rate) | |
| | Score: | 0.8% | v/v | |
| 14 | Pre-emergent | | | 95 |
| | Everest: | 15 | gai/ha | |
| | Pro Surf: | 0.25% | v/v | |
| | Post-emergent | | | |
| | Everest: | 15 | gai/ha | |
| | Pro Surf: | 0.25% | v/v | |
| 15 | Post-emergent | | 93.8 | |
| | Horizon: | 56 | gai/ha (full rate) | |
| | Score: | 0.8% | v/v | |

Table 3 illustrates that methods according to embodiments of the present invention can provide control of unwanted vegetation at least as well as, and in some cases superior to, traditional methods of controlling unwanted vegetation through full rate post-emergent application of a post-emergent herbicide. These results illustrate the significant reduction in the post-emergent application amount of herbicidally active ingredients necessary for control of unwanted vegetation. For instance, the post-emergent application of clodinafop can range from about 7 to about 28 grams of active per hectare, 7 to about 14 grams of active per hectare, or alternatively from about 14 to about 28 grams of active per hectare.

Moreover, the total amount of herbicidally active ingredient, according to certain embodiments of the present invention, can be less than the amount of active ingredient necessary to achieve similar results through the traditionally recommended approach for controlling unwanted vegetation by treating a planting site with a post-emergent treatment alone. For example, only 34 grams of active per hectare (i.e., 20 grams of active per hectare of EVEREST® plus 14 grams of active per hectare of HORIZON®) were used to control the unwanted vegetation in Site No. 10 as compared to the 56 grams of active per hectare used in Site No. 15. Furthermore, despite utilizing a total reduced amount of herbicidally active, the percent control of unwanted vegetation in Site No. 10 was superior to that illustrated in Site No. 15. Accordingly, the total amount of active ingredient used, according to this particular embodiment, was about 60% of the amount required by the traditionally recommended method.

### Example 4

A study was conducted to test various application methods using flucarbazone-sodium (PREPARE) in a pre-emergent application followed by post-emergent application with flucarbazone-sodium (EVEREST®). The results are illustrated in Table 4.

To better evaluate the ability of each treatment scheme in controlling unwanted vegetation in a planting site, a group of nearly identical crop planting sites (Site 1-Site 9) were subjected to different treatment schemes. Site No. 1 was untreated to act as a control site. Sites No. 2-Sites No. 9 were treated with different sequential pre-emergent and post-emergent treatment schemes. Site No. 2-Site No. 9 received an initial treatment of glyphosate to remove any pre-existing weeds in the test sites to ensure a more accurate determination of the viability of each treatment scheme. For Site No. 3-Site No. 7, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Treatment rate for each scheme was based on the recommended rate provided on the product label (grams of active ingredient per hectare). Since the label provided a range, the rate is based on the lower recommended rate from the label range. For example, post-emergent application of flucarbazone-sodium for control of wild oat can be made between 20 grams-30 grams of active ingredient per hectare depending on wild oat density. In the untreated site (Site No. 1), weeds germinated and grew to cover the site. Thus, Site No. 1 showed 0% weed control. The remaining sites were allowed the same amount of time for weed growth and were visually compared to an untreated crop planting site (Site No. 1). The percent control of yellow foxtail was observed as a comparison to Site No. 1. Thus, percent control for yellow foxtail was evaluated as the weed-free area in the particular site in comparison to the completely weed covered Site No. 1. Further, the respective crop yield for each crop planting site was also recorded.

As referenced in Table 4, glyphosate is a non-residual (i.e., does not exhibit significant residual soil activity), broad spectrum herbicide applied to emerged and actively growing weeds. Ammonium sulphate is a commercially available fertilizer blend used as an adjuvant to improve performance of glyphosate. Dicamba and pyraflufen are commercially available herbicides used to increase the activity and broadleaf weed spectrum of the pre-emergent herbicides. DISCOVER® NG is a commercially available grassy weed herbicide used post-emergent in cereal crops. WIDEMATCH® (fluoroxypyr+clopyralid) and MCPA are commercially available post-emergent herbicides used for the control of broadleaf weeds in cereal crops.

TABLE 4

| | | | % Control of | |
|---|---|---|---|---|
| | Treatment Scheme and | | Yellow Foxtail | |
| Site | application rate in grams | | at 65 days after | Crop Yield |
| No. | of active per hectare | | application | (Bu./Acre) |
| 1 | Untreated | | 0 | 61.4 |
| 2 | Pre-emergent | | 0 | 63.2 |
| | Glyphosate | 450 | | |
| | Ammonium sulphate | 1.12 kg/ha | | |
| | Post-emergent | | | |
| | Widematch | 105 | | |
| | MCPA | 500 | | |
| 3 | Pre-emergent | | 43 | 62.2 |
| | Glyphosate | 450 | | |
| | Ammonium sulphate | 1.12 kg/ha | | |
| | PrePare | 15 | | |
| | Post-emergent | | | |
| | Widematch | 210 | | |
| | MCPA | 280 | | |
| 4 | Pre-emergent | | 47 | 62.9 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Widematch | 210 | | |
| | MCPA | 280 | | |
| 5 | Pre-emergent | | 45 | 62.4 |
| | Glyphosate | 450 | | |
| | Ammonium sulphate | 1.12 kg/ha | | |
| | PrePare | 15 | | |
| | Pyraflufen | 1.83 | | |
| | Post-emergent | | | |
| | Widematch | 210 | | |
| | MCPA | 280 | | |
| 6 | Pre-emergent | | 90 | 62.5 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Everest | 10 | | |
| | Widematch | 210 | | |
| | MCPA | 280 | | |
| 7 | Pre-emergent | | 91 | 62.5 |
| | Glyphosate | 450 | | |
| | Ammonium sulphate | 1.12 kg/ha | | |
| | PrePare | 15 | | |
| | Pyraflufen | 1.83 | | |
| | Post-emergent | | | |
| | Everest | 10 | | |
| | Widematch | 210 | | |
| | MCPA | 280 | | |
| 8 | Pre-emergent | | 76 | 61.2 |
| | Glyphosate | 450 | | |
| | Ammonium sulphate | 1.12 kg/ha | | |
| | Post-emergent | | | |
| | Everest | 20 | | |
| | Widematch | 210 | | |
| | MCPA | 280 | | |
| 9 | Pre-emergent | | 86 | 61.9 |
| | Glyphosate | 450 | | |
| | Ammonium sulphate | 1.12 kg/ha | | |
| | Post-emergent | | | |
| | Discover NG | 56 | | |
| | Widematch | 210 | | |
| | MCPA | 280 | | |

As illustrated by Table 4, unwanted vegetation consumed the entire untreated planting site (Site No. 1). As such, Site No. 1 exhibited 0% control of the unwanted vegetation and the crop yield was 61.4 bushels per acre. Site No. 2 did not receive a grassy weed herbicide such as PREPARE, EVEREST®, or DISCOVER® NG and exhibited 0% control of yellow foxtail and crop yield of 63.2 bushels per acre. The traditional treatment scheme was represented by Site No. 8 and Site No. 9. Specifically Site No. 8 or Site No. 9 was not provided with any residual pre-emergent treatment (e.g., PREPARE). Instead, a low post-emergent rate application of EVEREST® was provided to Site No. 8 and a full post-emergent rate application of DISCOVER® NG was provided to Site No. 9 in a post-emergent application tank-mixed with the broadleaf herbicide, WIDEMATCH® and MCPA. As illustrated in Table 4, Site No. 8 and Site No. 9 exhibited a 76% and 86% control, respectively, of yellow foxtail. Further, Site No. 8 and Site No. 9 provided wheat yield of 61.2 and 61.9 bushels per acre, respectively.

Table 4 illustrates that methods according to embodiments of the present invention can provide control of unwanted vegetation at least as well as, and in some cases superior to, traditional methods of controlling unwanted vegetation through full rate, post-emergent application of a traditional post-emergent herbicide. For instance, a pre-emergent application of 15 grams of active per hectare of PREPARE to Site No. 3 provided a 43% control of yellow foxtail and Site No. 4 exhibited a 47% control of yellow foxtail. Additionally, a split rate of flucarbazone (25 grams of active per hectare) was applied to both Site No. 6 and Site No. 7 as a sequential pre-emergent and post-emergent application (i.e., 15 grams of active per hectare as PREPARE in a pre-emergent fashion followed by 10 grams of active per hectare of EVEREST® applied in a post-emergent fashion). The split application of flucarbazone increased the level of control of yellow foxtail to 90% in Site No. 6 and 91% control in Site No. 7. The traditional recommended approach for controlling yellow foxtail by treating a planting site with a post-emergent treatment of flucarbazone is 30 grams active ingredient per hectare.

### Example 5

An additional study was conducted to test various application methods using flucarbazone-sodium (PREPARE) in a pre-emergent application followed by post-emergent application with clodinafop (HORIZON®) and flucarbazone-sodium (EVEREST®) for control of wild oat. The results are illustrated in Table 5.

To better evaluate the ability of each treatment scheme in controlling unwanted vegetation in a planting site, a group of nearly identical crop planting sites (Site 1-Site 14) were subjected to different treatment schemes. Site No. 1 was untreated to act as a control site. Site No. 2-Site No. 14 were treated with different sequential pre-emergent and post-emergent treatment schemes. Site No. 2-Site No. 14 received an initial treatment of glyphosate to remove any pre-existing weeds in the test sites to ensure a more accurate determination of the viability of each treatment scheme. For Site No. 3-Site No. 12, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Treatment rates for each scheme were based on the recommended rate provided on the product label (i.e., grams of active ingredient per hectare). Since the labels provide a range, the rates applied are based on the lower recommended rate from the label range. For example the post-emergent rate of flucarbazone-sodium for control of wild oat is between 20 grams—30 grams of active ingredient per hectare. In the untreated site (Site No. 1), weeds germinated and grew to cover the site. Thus, Site No. 1 showed 0% weed control. The remaining sites were allowed the same amount of time for weed growth and were visually compared to an untreated crop planting site (Site No. 1). The percent control of wild oat was observed as a comparison to Site No. 1. Thus, percent control for wild oat was evaluated as the weed-free area in the particular site in comparison to the completely weed covered Site No. 1. Further, the respective crop yield for each crop planting site was also recorded.

As referenced in Table 5, glyphosate is a non-residual, broad spectrum herbicide applied to emerged and actively growing weeds. Ammonium sulphate is a commercially available fertilizer blend used as an adjuvant to improve performance of glyphosate. Dicamba and pyraflufen are commercially available herbicides used to increase the activity and broadleaf weed spectrum of the pre-emergent herbicides. Tank-mixes for post-emergent application of HORIZON® included SCORE®, which is a liquid spray tank adjuvant comprising an emulsifiable oil product. SCORE® is an adjuvant containing 83% w/w of a hyrdrocarbon blend and 17% w/w of surfactant. Surfactants are typically petroleum or vegetable oil based product used to reduce the surface tension of a spray solution. PRESTIGE® A (fluoroxypyr) and PRESTIGE® B (clopyralid+MCPA) are commercially available post-emergent herbicides used for the control of broadleaf weeds in cereal crops.

TABLE 5

| | | | % Control of | |
|---|---|---|---|---|
| | Treatment Scheme | | Wild Oat at | |
| Site | and application rate in | | 81 days after | Crop Yield |
| No. | grams of active per hectare | | application | (Bu./Acre) |
| 1 | Untreated | | 0 | 32.5 |
| 2 | Pre-emergent | | 15 | 48.4 |
| | Glyphosate | 450 | | |
| | Ammonium sulphate | 1.12 kg/ha | | |
| | Post-emergent | | | |
| | Prestige A | 105 | | |
| | Prestige B | 500 | | |
| 3 | Pre-emergent | | 69 | 58 |
| | Glyphosate | 450 | | |
| | Ammonium sulphate | 1.12 kg/ha | | |
| | PrePare | 10 | | |
| | Post-emergent | | | |
| | Prestige A | 105 | | |
| | Prestige B | 500 | | |
| 4 | Pre-emergent | | 83 | 57.4 |
| | Glyphosate | 450 | | |
| | Ammonium sulphate | 1.12 kg/ha | | |
| | PrePare | 15 | | |
| | Post-emergent | | | |
| | Prestige A | 105 | | |
| | Prestige B | 500 | | |
| 5 | Pre-emergent | | 69 | 52.1 |
| | Glyphosate | 450 | | |
| | Ammonium sulphate | 1.12 kg/ha | | |
| | PrePare | 10 | | |
| | Dicamba | 70 | | |
| | Post-emergent | | | |
| | Prestige A | 105 | | |
| | Prestige B | 500 | | |
| 6 | Pre-emergent | | 76 | 59.3 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Prestige A | 105 | | |
| | Prestige B | 500 | | |
| 7 | Pre-emergent | | 63 | 53.3 |
| | Glyphosate | 450 | | |
| | Ammonium sulphate | 1.12 kg/ha | | |
| | PrePare | 10 | | |
| | Pyraflufen | 1.83 | | |
| | Post-emergent | | | |
| | Everest | 10 | | |
| | Prestige A | 105 | | |
| | Prestige B | 500 | | |
| 8 | Pre-emergent | | 71 | 64.2 |
| | Glyphosate | 450 | | |
| | Ammonium sulphate | 1.12 kg/ha | | |
| | PrePare | 15 | | |
| | Pyraflufen | 1.83 | | |
| | Post-emergent | | | |
| | Everest | 10 | | |
| | Prestige A | 105 | | |
| | Prestige B | 500 | | |
| 9 | Pre-emergent | | 90 | 64.3 |
| | Glyphosate | 450 | | |
| | Ammonium sulphate | 1.12 kg/ha | | |
| | PrePare | 10 | | |
| | Post-emergent | | | |
| | Everest | 10 | | |
| | Prestige A | 105 | | |
| | Prestige B | 500 | | |
| 10 | Pre-emergent | | 95 | 62.7 |
| | Glyphosate | 450 | | |
| | Ammonium sulphate | 1.12 kg/ha | | |
| | PrePare | 15 | | |
| | Post-emergent | | | |
| | Everest | 10 | | |
| | Prestige A | 105 | | |
| | Prestige B | 500 | | |
| 11 | Pre-emergent | | 94 | 57.9 |
| | Glyphosate | 450 | | |
| | Ammonium sulphate | 1.12 kg/ha | | |
| | PrePare | 10 | | |
| | Post-emergent | | | |
| | Horizon | 28 | | |
| | Score | 0.8% v/v | | |
| | Prestige A | 105 | | |
| | Prestige B | 500 | | |
| 12 | Pre-emergent | | 94 | 66.5 |
| | Glyphosate | 450 | | |
| | Ammonium sulphate | 1.12 kg/ha | | |
| | PrePare | 15 | | |
| | Post-emergent | | | |
| | Horizon | 28 | | |
| | Score | 0.8% v/v | | |
| | Prestige A | 105 | | |
| | Prestige B | 500 | | |
| 13 | Pre-emergent | | 86 | 60.9 |
| | Glyphosate | 450 | | |
| | Ammonium sulphate | 1.12 kg/ha | | |
| | Post-emergent | | | |
| | Everest | 20 | | |
| | Prestige A | 105 | | |
| | Prestige B | 500 | | |
| 14 | Pre-emergent | | 94 | 63.5 |
| | Glyphosate | 450 | | |
| | Ammonium sulphate | 1.12 kg/ha | | |
| | Post-emergent | | | |
| | Horizon | 56 | | |
| | Score | 0.8% v/v | | |
| | Prestige A | 105 | | |
| | Prestige B | 500 | | |

Table 5 illustrates methods according to embodiments of the present invention can provide control of unwanted vegetation at least as well as, and in some cases superior to, traditional methods of controlling unwanted vegetation through full rate post-emergent application of a post-emergent herbicide. As illustrated by Table 5, unwanted vegetation consumed the entire untreated planting site (Site No. 1). As such, Site No. 1 exhibited 0% control of the unwanted vegetation and the crop yield was only 32.5 bushels per acre. Site No. 2 did not receive a wild oat herbicide such as PREPARE, EVEREST®, or HORIZON®, however exhibited 15% control of wild oat due to the glyphosate application made prior to crop emergence and resulted in an increase in crop yield of 48.4 bushels per acre. The traditional treatment scheme was represented by Site No. 13 and Site No. 14. Specifically, both Site No. 13 and Site No. 14 were not provided with any residual pre-emergent treatment (i.e., pre-emergent application of a typically recognized post-emergent having residual soil activity such as PREPARE). Instead, a low post-emergent rate application of 20 grams of active ingredient per hectare of EVEREST® was provided to Site No. 13 and a full post-emergent rate application of HORIZON® was provided to Site No. 14 in a post-emergent application tank-mixed with the broadleaf herbicide, PRESTIGE® A and B. As illustrated in Table 4, 86% and 94% of the planting sites for Site No. 13 and Site No. 14, respectively, were controlled with respect to wild oat. Further, Site No. 13 and Site No. 14 provided wheat yield of 60.9 and 63.5 bushels per acre, respectively.

Site No. 9 provides one example that demonstrates the effectiveness of applying a post-emergent herbicide, according to embodiments of the present invention, in a pre-emergent fashion for controlling unwanted vegetation. According to embodiments of the present invention, the pre-emergent application of a typically recognized post-emergent herbicide having the necessary residual activity significantly weakens those weeds that continue to grow with the crop. As Site No. 9 demonstrated, applying sequential herbicide application of flucarbazone-sodium as 10 grams of active ingredient per hectare in a pre-emergent fashion followed by a sequential post-emergent application of 10 grams of active per hectare provided greater control of wild oat than observed in Site No. 13. Site No. 13 received 20 grams of flucarbazone per hectare of EVEREST® as a single, post-emergent application. There was also an increase in crop yield harvested from Site No. 9 compared to Site No. 13.

These results further illustrate the significant reduction in the post-emergent application amount of herbicidally active ingredient necessary for control of unwanted vegetation. For instance, a pre-emergent application of PREPARE applied at 15 grams of active ingredient per hectare followed by a post-emergent application of HORIZON® applied at 28 grams of active ingredient per hectare was applied to Site No. 12 instead of a traditional, post-emergent application of 56 grams of active ingredient per hectare of HORIZON® applied to Site No. 14 provided equivalent weed control. Also, Site No. 12 showed a slight increase in crop yield compared to yield observed in Site No. 14. These results further illustrate reduction in post-emergent application amount of herbicidally active ingredient necessary for control of unwanted vegetation. The post-emergent rate of HORIZON® application can be reduced to 28 grams of active ingredient per hectare.

### Example 6

A study was conducted to test various application methods using flucarbazone-sodium (PREPARE) in a pre-emergent application followed by post-emergent application with clodinafop (DISCOVER® NG), pinoxaden (AXIAL™ XL) and flucarbazone-sodium (EVEREST®) for control of wild oat. The results are illustrated in Table 6.

To better evaluate the ability of each treatment scheme in controlling unwanted vegetation in a planting site, a group of nearly identical crop planting sites (Site 1-Site 7) were subjected to different treatment schemes. Site No. 1 was to act as a control site and Site No. 2-Sites No. 7 were treated with a pre-emergent treatment or sequential pre-emergent and post-emergent treatment schemes. Treatment rates were based on the recommended rate provided on the product label (grams of active ingredient per hectare). Since the label provides a range, the rate applied is based on the lower recommended rate from the label range. For example the post-emergent rate of flucarbazone-sodium for control of wild oat is between 20 grams-30 grams of active ingredient per hectare. Any pre-existing weeds that had germinated and grew to cover the test sites (i.e., Site No. 1-Site No. 7) were removed with glyphosate to ensure a more accurate determination of the viability of each treatment scheme. For Site No. 2-Site No. 6, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Site No. 1 was not treated with a pre-emergent or a post-emergent application of a herbicidally active compound according to embodiments of the present invention, allowing wild oat to emerge either with the crop or after crop emergence. Although, Site No. 1 received a pre-burn treatment with glyphosate, this treatment only acts on existing weeds. Thus, Site No. 1 showed 0% weed control. The remaining sites were allowed the same amount of time for weed growth and were visually compared to crop planting site (Site No. 1). The percent control of wild oat was observed as a comparison to Site No. 1. Thus, percent control for wild oat was evaluated as the weed-free area in the particular site in comparison to the completely weed covered Site No. 1.

As referenced in Table 6, glyphosate is a non-residual, broad spectrum herbicide applied to emerged and actively growing weeds. Ammonium sulphate is a commercially available fertilizer blend used as an adjuvant to improve performance of glyphosate. Dicamba is a commercially available herbicide used to increase the activity and broadleaf weed spectrum of the pre-emergent herbicides. Basic Blend is a commercially available product commonly used in herbicidal applications. Basic Blend adjuvants contain different components that have different functions within the composition of the adjuvant, such as increasing water pH to increase water solubility of certain herbicides.

TABLE 6

| | | | % Control of | |
|---|---|---|---|---|
| | Treatment Scheme and | | Wild Oat at | |
| Site | application rate in grams | | 89 days after | Crop Yield |
| No. | of active per hectare | | application | (Bu./Acre) |
| 1 | Pre-emergent | | 0 | — |
| | Glyphosate | 450 | | |
| | Ammonium sulphate | 1.12 kg/ha | | |
| 2 | Pre-emergent | | 0 | — |
| | Glyphosate | 450 | | |
| | Ammonium sulphate | 1.12 kg/ha | | |
| | PrePare | 15 | | |
| | Dicamba | 70 | | |
| 3 | Pre-emergent | | 96 | — |
| | Glyphosate | 450 | | |
| | Ammonium sulphate | 1.12 kg/ha | | |
| | PrePare | 15 | | |
| | Dicamba | 70 | | |
| | Post-emergent | | | |
| | Everest | 10 | | |
| | Basic Blend | 1% v/v | | |
| 4 | Pre-emergent | | 95 | — |
| | Glyphosate | 450 | | |
| | Ammonium sulphate | 1.12 kg/ha | | |
| | PrePare | 15 | | |
| | Dicamba | 70 | | |
| | Post-emergent | | | |
| | Everest | 15 | | |
| | Basic Blend | 1% v/v | | |
| 5 | Pre-emergent | | 95 | — |
| | Glyphosate | 450 | | |
| | Ammonium sulphate | 1.12 kg/ha | | |
| | PrePare | 15 | | |
| | Dicamba | 70 | | |
| | Post-emergent | | | |
| | Olympus | 10 | | |
| | Basic Blend | 1% v/v | | |
| 6 | Pre-emergent | | 97 | — |
| | Glyphosate | 450 | | |
| | Ammonium sulphate | 1.12 kg/ha | | |
| | PrePare | 15 | | |
| | Dicamba | 70 | | |
| | Post-emergent | | | |
| | Discover NG | 28 | | |
| 7 | Pre-emergent | | 98 | — |
| | Glyphosate | 450 | | |
| | Ammonium sulphate | 1.12 kg/ha | | |
| | Post-emergent | | | |
| | Axial XL | 60 | | |

As illustrated by Table 6, unwanted vegetation consumed the entire untreated planting site (Site No. 1). As such, Site No. 1 exhibited 0% control of the unwanted vegetation. The traditional treatment scheme was represented by Site No. 7. Specifically, Site No. 7 was not provided with a pre-emergent treatment of a typically recognized post-emergent herbicide exhibiting residual soil activity. Instead, a full, post-emergent rate application of AXIAL™ XL at 60 grams of active ingredient per hectare was provided to Site No. 7 in a post-emergent application. As illustrated in Table 6, 98% of the planting site of Site No. 7 was controlled with respect to wild oat. However, similar level of wild oat control was observed in Site No. 6. The level of control in Site No. 6 was 97% using a pre-emergent application of PREPARE applied at 15 grams of active ingredient per hectare followed with the sequential post-emergent application of DISCOVER® NG at 28 grams of active ingredient per hectare. The total amount of herbicidally active ingredient was shown to be less in Site No. 6 than the amount of active ingredient in Site No. 7, which represented a traditional approach to controlling unwanted vegetation with only a post-emergent treatment. Table 6 illustrates that methods according to embodiments of the present invention can provide control of unwanted vegetation at least as well as traditional methods of controlling unwanted vegetation through full rate post-emergent application of a post-emergent herbicide observed in Site No. 7.

Moreover, the total amount of herbicidally active ingredient, according to certain embodiments of the present invention, can be less than the amount of active ingredient necessary to achieve similar results through the traditionally recommended approach for controlling unwanted vegetation by treating a planting site with a post-emergent application alone. As illustrated by Site No. 4, flucarbazone applied at 15 grams of active ingredient per hectare as a pre-emergent followed by 15 grams of active ingredient per hectare applied as a post-emergent provided 95% control of wild oat. The total amount of herbiciadally active compounds applied was 30 grams of active ingredient per hectare. In Site No. 3, 25 grams of active ingredient per hectare (i.e., 15 grams of active ingredient per hectare of PREPARE followed by 10 grams of active ingredient per hectare of EVEREST®) provided similar level of control of unwanted vegetation as Site No. 4. Additionally, 25 grams of active ingredient per hectare of total active ingredient (i.e., 15 grams of active ingredient per hectare of PREPARE followed by 10 grams of active ingredient per hectare of OLYMPUS®) were used to control unwanted vegetation in Site No. 5 as OLYMPUS® was used at below recommended label rates. Site No. 5 shows effectiveness of using other group 2 herbicides such as OLYMPUS® (at a reduced rate) following a pre-emergent application of flucarbazone sodium (PREPARE) to provide a similar level of control.

### Example 7

Another study was conducted to test various application methods using flucarbazone-sodium (PREPARE) in a pre-emergent application followed by post-emergent application with propoxycarbazone (OLYMPUS®), pyroxsulam (Simplicity®), sulfosulfuron (MAVERICK®), pinoxaden (AXIAL™ XL) and flucarbazone-sodium (EVEREST®) to control Bromus secalinus and Foxtail Barley. The results are illustrated in Table 7.

To better evaluate the ability of each treatment scheme in controlling unwanted vegetation in a planting site, a group of nearly identical crop planting sites (Site 1-Site 10) were subjected to different treatment schemes. Again, Site No. 1 was a control site. Sites No. 2-Sites No. 10 were treated with either a pre-emergent treatment or sequential pre-emergent and post-emergent treatment schemes. Treatment rates were based on the recommended lower rate provided on the product label (grams of active ingredient per hectare). In all sites, pre-existing weeds that had germinated and grew to cover the sites were removed with glyphosate to ensure a more accurate determination of the viability of each treatment scheme. For Site No. 2-Site No. 10, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Site No. 1 was not treated with a pre-emergent treatment or a post-emergent treatment, allowing Bromus secalinus and Foxtail Barley to emerge either with the crop or after crop emergence. Although, Site No. 1 received a pre-burn treatment with glyphosate, this treatment only acts on existing weeds. Thus, Site No. 1 showed 5% and 0% control of Bromus secalinus and Foxtail Barley, respectively due to the pre-emergent application of glyphosate. The remaining sites were allowed the same amount of time for weed growth and were visually compared to crop planting site (Site No. 1). The percent control of Bromus secalinus and Foxtail Barley was observed as a comparison to Site No. 1. Thus, percent control for Bromus secalinus and Foxtail Barley were evaluated as the weed-free area in the particular site in comparison to the completely weed covered Site No. 1.

As referenced in Table 7, glyphosate is a non-residual, broad spectrum herbicide applied to emerged and actively growing weeds. Ammonium sulphate is a commercially available fertilizer blend used as an adjuvant to improve performance of glyphosate. Dicamba is a commercially available herbicide used to increase the activity and broadleaf weed spectrum of the pre-emergent herbicides. Basic Blend is a commercially available product commonly used in herbicidal applications. Basic Blend adjuvants contain different components that have different functions within the composition of the adjuvant, such as increasing water pH to increase water solubility of certain herbicides.

TABLE 7

| | | | % Control of Cheat | % Control of Foxtail | Crop |
|---|---|---|---|---|---|
| Site | Treatment Scheme and application | | (Bromus secalinus) at 86 | Barley at 86 days | Yield |
| No. | rate in grams of active per hectare | | days after application | after application | (Bu./Acre) |
| 1 | Pre-emergent | | 5 | 0 | — |
| | Glyphosate | 450 | | | |
| | Ammonium sulphate | 1.12 kg/ha | | | |
| 2 | Pre-emergent | | 69 | 25 | — |
| | Glyphosate | 450 | | | |
| | Ammonium sulphate | 1.12 kg/ha | | | |
| | PrePare | 15 | | | |
| | Dicamba | 70 | | | |
| 3 | Pre-emergent | | 80 | 73 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Everest | 10 | | | |
| | Basic Blend | 1% v/v | | | |
| 4 | Pre-emergent | | 92 | 95 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Everest | 15 | | | |
| | Basic Blend | 1% v/v | | | |
| 5 | Pre-emergent | | 96 | 95 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Olympus | 10 | | | |
| | Basic Blend | 1% v/v | | | |
| 6 | Pre-emergent | | 98 | 95 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Everest | 10 | | | |
| | Olympus | 10 | | | |
| | Basic Blend | 1% v/v | | | |
| 7 | Pre-emergent | | 92 | 80 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Simplicity | 15 | | | |
| | Basic Blend | 1% v/v | | | |
| 8 | Pre-emergent | | 92 | 85 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Simplicity | 7.5 | | | |
| | Basic Blend | 1% v/v | | | |
| 9 | Pre-emergent | | 93 | 95 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Maverick | 13.1 | | | |
| | Basic Blend | 1% v/v | | | |
| 10 | Pre-emergent | | 57 | 18 | — |
| | Glyphosate | 450 | | | |
| | Ammonium sulphate | 1.12 kg/ha | | | |
| | PrePare | 15 | | | |
| | Dicamba | 70 | | | |
| | Post-emergent | | | | |
| | Axial XL | 30 | | | |

Table 7 illustrates the effectiveness of some, but not all, embodiments of the present invention. For instance, Table 7 illustrates the use of commercially available herbicides where a reduced total amount of post-emergent herbicide is applied to the crop planting site to control unwanted vegetation. In Site No. 1, unwanted vegetation consumed the entire untreated planting site. Site No. 4 received 30 grams of active ingredient per hectare as a sequential application of PREPARE at 15 grams of active ingredient per hectare as a pre-emergent application and EVEREST® at 15 grams of active ingredient per hectare as a post-emergent application.

As a result of the sequential application to Site No. 4, the level of control of unwanted vegetation was 92% for Bromus secalinus and 95% for Foxtail Barley. The same amount of active ingredient was applied to Site No. 7, which received 30 grams of active ingredient per hectare as a sequential application of PREPARE at 15 grams of active ingredient per hectare as a pre-emergent application and SIMPLICITY® at 15 grams of active ingredient per hectare as a post-emergent application. As a result, 92% and 80% control of Bromus secalinus and Foxtail Barley, respectively, was observed in the treated area at Site No. 7. The total amount of herbicidally active ingredient, was reduced in Site No. 8 to 22.5 grams of active ingredient per hectare applied as a sequential pre-emergent and post-emergent application (i.e., 15 grams of active ingredient per hectare of PREPARE applied as a pre-emergent plus 7.5 grams of active ingredient per hectare of SIMPLICITY® applied as a post-emergent) which provided similar level of control of unwanted vegetation as Site No. 8. Further, similar level of control of unwanted vegetation was observed in Site No. 5 and Site No. 9 with other commercially available group 2 herbicides.

### Example 8

Another study was conducted to test various application methods using flucarbazone-sodium (PrePare) in a pre-emergent application followed by post-emergent application with propoxycarbazone (OLYMPUS®), pyroxsulam (SIMPLICITY®), sulfosulfuron (MAVERICK®), pinoxaden (AXIAL™ XL) and flucarbazone-sodium (EVEREST®) to control Wild Oat. The results are illustrated in Table 8.

To better evaluate the ability of each treatment scheme in controlling unwanted vegetation in a planting site, a group of nearly identical crop planting sites (Site 1-Site 10) were subjected to different treatment schemes. Site No. 1 was again a control site and sites No. 2-Sites No. 10 were treated with varying treatment schemes. Again, the treatment rates were based on the recommended lower rate provided on the product label (grams of active ingredient per hectare). In all sites, any pre-existing weeds that germinated and grew to cover the sites were removed with glyphosate to ensure a more accurate determination of the viability of each treatment scheme. For Site No. 2-Site No. 10, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Site No. 1 was not treated with a pre-emergent application or post-emergent application of herbicidally active compounds, allowing Wild Oat to emerge either with the crop or after crop emergence. Site No. 1 showed 27% weed control due to glyphosate application. The remaining sites were allowed the same amount of time for weed growth and were visually compared to crop planting site (Site No. 1). The percent control of Wild Oat was observed as a comparison to Site No. 1. Thus, percent control for Wild Oat was evaluated as the weed-free area in the particular site in comparison to the completely weed covered Site No. 1. Further, the respective crop yield for each crop planting site was also recorded.

As referenced in Table 8, glyphosate is a non-residual, broad spectrum herbicide applied to emerged and actively growing weeds. Ammonium sulphate is a commercially available fertilizer blend used as an adjuvant to improve performance of glyphosate. Dicamba is a commercially available herbicide used to increase the activity and broadleaf weed spectrum of the pre-emergent herbicides. Basic Blend is a commercially available product commonly used in herbicidal applications. Basic Blend adjuvants contain different components that have different functions within the composition of the adjuvant, such as increasing water pH to increase water solubility of certain herbicides.

TABLE 8

| | Treatment Scheme | | % Control of | |
|---|---|---|---|---|
| | and application | | Wild Oat at | |
| Site | rate in grams of | | 86 days after | Crop Yield |
| No. | active per hectare | | application | (Bu./Acre) |
| 1 | Pre-emergent | | 27 | 20.1 |
| | Glyphosate | 450 | | |
| | Ammonium sulphate | 1.12 kg/ha | | |
| 2 | Pre-emergent | | 47 | 25.3 |
| | Glyphosate | 450 | | |
| | Ammonium sulphate | 1.12 kg/ha | | |
| | PrePare | 15 | | |
| | Dicamba | 70 | | |
| 3 | Pre-emergent | | 96 | 22.3 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Everest | 10 | | |
| | Basic Blend | 1% v/v | | |
| 4 | Pre-emergent | | 95 | 19.7 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Everest | 15 | | |
| | Basic Blend | 1% v/v | | |
| 5 | Pre-emergent | | 90 | 22.9 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Olympus | 10 | | |
| | Basic Blend | 1% v/v | | |
| 6 | Pre-emergent | | 98 | 25 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Everest | 10 | | |
| | Olympus | 10 | | |
| | Basic Blend | 1% v/v | | |
| 7 | Pre-emergent | | 99 | 20.3 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Simplicity | 15 | | |
| | Basic Blend | 1% v/v | | |
| 8 | Pre-emergent | | 99 | 25.1 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Simplicity | 7.5 | | |
| | Basic Blend | 1% v/v | | |
| 9 | Pre-emergent | | 98 | 29.7 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Maverick | 13.1 | | |
| | Basic Blend | 1% v/v | | |
| 10 | Pre-emergent | | 94 | 26.0 |
| | Glyphosate | 450 | | |
| | Ammonium sulphate | 1.12 kg/ha | | |
| | PrePare | 15 | | |
| | Dicamba | 70 | | |
| | Post-emergent | | | |
| | Axial XL | 30 | | |

As illustrated by Table 8, unwanted vegetation consumed essentially the entire untreated planting site (Site No. 1). However, 27% of Site No. 1 exhibited some control of the unwanted vegetation apparently due to the initial application of glyphosate. Since glyphosate was applied to all sites, it is assumed that glyphosate contributed similar level of control to all sites as observed in Site No. 1. Site No. 4 was provided with a sequential application of 15 grams of active ingredient per hectare applied in a pre-emergent fashion followed by 15 grams of active ingredient per hectare applied in a post-emergent fashion of flucarbazone-sodium for a total active ingredient of 30 grams to the site. As illustrated in Table 8, 95% of the planting site was controlled with respect to wild oat.

The total amount of active ingredient applied to Site No. 7 was grams of active ingredient per hectare. In particular, 15 grams of active ingredient per hectare (i.e., PREPARE) was applied in a pre-emergent fashion followed by 15 grams of active ingredient per hectare (i.e., SIMPLICITY®) applied in a post emergent fashion. As a result, 99% control of wild oat was observed in the treated area at Site No. 7.

The total amount of herbicidally active ingredient was reduced in Site No. 8 to 22.5 grams of active ingredient per hectare applied as a sequential pre-emergent and post-emergent application (i.e., 15 grams of active ingredient per hectare of PREPARE was applied in a pre-emergent fashion and 7.5 grams of active ingredient per hectare of SIMPLICITY® was applied in a post-emergent fashion). The treatment scheme applied to Site No. 8 provided a similar level of control of unwanted vegetation as Site No. 7. A similar level of control of unwanted vegetation was observed in Site No. 5 and Site No. 9. Post-emergent applications of commercially available group 2 herbicides, OLYMPUS® and MAVERICK®, were applied in a post-emergent fashion as part of sequential applications to sites that had received a pre-emergent application of PREPARE.

### Example 9

A study was conducted to test various application methods using flucarbazone-sodium (PREPARE) in a pre-emergent application followed by post-emergent application with clodinafop (HORIZON®). The results are illustrated in Table 9.

To better evaluate the ability of each treatment scheme in controlling unwanted vegetation in a planting site, a group of nearly identical crop planting sites (Site 1-Site 18) were subjected to different treatment schemes. Site No. 1 was to act as a control site and Sites No. 2-Sites No. 18 received varying treatment schemes. Treatment rates were based on the recommended lower rate provided on the product label (grams of active ingredient per hectare). In all sites, pre-existing weeds that had germinated and grew to cover the sites were removed with glyphosate to ensure a more accurate determination of the viability of each treatment scheme. For Site No. 2-Site No. 14, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Site No. 1 was not treated in any manner, allowing wild oat to emerge either with the crop or after crop emergence. Although, Site No. 1 received a pre-burn treatment with glyphosate, this treatment only acts on existing weeds. Thus, Site No. 1 showed 0% weed control. The remaining sites were allowed the same amount of time for weed growth and were visually compared to an untreated crop planting site (Site No. 1). The percent control of wild oat and green foxtail was observed as a comparison to Site No. 1. Thus, percent control for wild oat and green foxtail was evaluated as the weed-free area in the particular site in comparison to the completely weed covered Site No. 1. Further, the respective crop yield for each crop planting site was also recorded.

As referenced in Table 9, glyphosate is a non-residual, broad spectrum herbicide applied to emerged and actively growing weeds. Ammonium sulphate is a commercially available fertilizer blend used as an adjuvant to improve performance of glyphosate. Dicamba is a commercially available herbicides used to increase the activity and broadleaf weed spectrum of the pre-emergent herbicides. Tank-mixes for post-emergent application included Score. Score is an adjuvant containing 83% w/w of a hydrocarbon blend and 17% w/w of surfactant. Surfactants are typically petroleum or vegetable oil based product used to reduce surface tension of spray solution. PRESTIGE® A (fluoroxypyr) and PRESTIGE® B (clopyralid+MCPA) are commercially available post-emergent herbicides used for the control of broadleaf weeds in cereal crops.

TABLE 9

| | | | % Control of Wild | % Control of Green | |
|---|---|---|---|---|---|
| Site | Treatment Scheme and application | | Oat at 84 days after | Foxtail at 84 days | Crop Yield |
| No. | rate in grams of active per hectare | | application | after application | (Bu./Acre) |
| 1 | Pre-emergent | | 0 | 0 | 57.6 |
| | Glyphosate | 450 | | | |
| | Ammonium sulphate | 2.5% v/v | | | |
| | Late Post-emergent | | | | |
| | Prestige A | 105 | | | |
| | Prestige B | 500 | | | |
| 2 | Pre-emergent | | 58 | 88 | 61.0 |
| | Glyphosate | 450 | | | |
| | Ammonium sulphate | 2.5% v/v | | | |
| | PrePare | 15 | | | |
| | Dicamba | 70 | | | |
| | Late Post-emergent | | | | |
| | Prestige A | 105 | | | |
| | Prestige B | 500 | | | |
| 3 | Pre-emergent | | 75 | 98 | 66.3 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 14 | | | |
| | Score Adjuvant | 0.8% v/v | | | |
| | Late Post-emergent | | | | |
| | Prestige A | 105 | | | |
| | Prestige B | 500 | | | |
| 4 | Pre-emergent | | 89 | 97 | 70.0 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 14 | | | |
| | Score Adjuvant | 0.8% v/v | | | |
| | Late Post-emergent | | | | |
| | Prestige A | 105 | | | |
| | Prestige B | 500 | | | |
| 5 | Pre-emergent | | 73 | 85 | 68.5 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 14 | | | |
| | Score Adjuvant | 0.8% v/v | | | |
| | Prestige A | 105 | | | |
| | Prestige B | 500 | | | |
| 6 | Pre-emergent | | 96 | 86 | 72.4 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 28 | | | |
| | Score Adjuvant | 0.8% v/v | | | |
| | Prestige A | 105 | | | |
| | Prestige B | 500 | | | |
| 7 | Pre-emergent | | 83 | 98 | 70.2 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 14 | | | |
| | Score Adjuvant | 0.8% v/v | | | |
| | Buctril M | 560 | | | |
| 8 | Pre-emergent | | 95 | 96 | 71.1 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 28 | | | |
| | Score Adjuvant | 0.8% v/v | | | |
| | Buctril M | 560 | | | |
| 9 | Pre-emergent | | 69 | 94 | 68.4 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 14 | | | |
| | Score Adjuvant | 0.8% v/v | | | |
| | Deploy | 15 | | | |
| 10 | Pre-emergent | | 86 | 84 | 69 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Horizon | 28 | | | |
| | Score Adjuvant | 0.8% v/v | | | |
| | Deploy | 15 | | | |
| 11 | Pre-emergent | | 98 | 99 | 66.4 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Everest | 10 | | | |
| | NIS Adjuvant | 0.25% v/v | | | |
| | Late Post-emergent | | | | |
| | Prestige A | 105 | | | |
| | Prestige B | 500 | | | |
| 12 | Pre-emergent | | 100 | 100 | 68.7 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Everest | 10 | | | |
| | Prestige A | 105 | | | |
| | Prestige B | 500 | | | |
| 13 | Pre-emergent | | 97 | 100 | 63.2 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Everest | 10 | | | |
| | Buctril M | 560 | | | |
| 14 | Pre-emergent | | 98 | 100 | 70.8 |
| | Glyphosate | 450 | | | |
| | Ammonium sulphate | 2.5% v/v | | | |
| | PrePare | 15 | | | |
| | Dicamba | 70 | | | |
| | Early Post-emergent | | | | |
| | Everest | 10 | | | |
| | NIS Adjuvant | 0.25% v/v | | | |
| | Deploy | 15 | | | |
| 15 | Pre-emergent | | 63 | 48 | 66.1 |
| | Glyphosate | 450 | | | |
| | Ammonium sulphate | 2.5% v/v | | | |
| | Early Post-emergent | | | | |
| | Horizon | 14 | | | |
| | Score Adjuvant | 0.8% v/v | | | |
| | Prestige A | 105 | | | |
| | Prestige B | 500 | | | |
| 16 | Pre-emergent | | 93 | 68 | 70.1 |
| | Glyphosate | 450 | | | |
| | Ammonium sulphate | 2.5% v/v | | | |
| | Early Post-emergent | | | | |
| | Horizon | 28 | | | |
| | Score Adjuvant | 0.8% v/v | | | |
| | Prestige A | 105 | | | |
| | Prestige B | 500 | | | |
| 17 | Pre-emergent | | 100 | 78 | 70.8 |
| | Glyphosate | 450 | | | |
| | Ammonium sulphate | 2.5% v/v | | | |
| | Early Post-emergent | | | | |
| | Horizon | 56 | | | |
| | Score Adjuvant | 0.8% v/v | | | |
| | Prestige A | 105 | | | |
| | Prestige B | 500 | | | |
| 18 | Pre-emergent | | 100 | 87 | 68.1 |
| | Glyphosate | 450 | | | |
| | Ammonium sulphate | 2.5% v/v | | | |
| | Early Post-emergent | | | | |
| | Everest | 10 | | | |
| | Prestige A | 105 | | | |
| | Prestige B | 500 | | | |

Table 9 illustrates that methods according to embodiments of the present invention can provide control of unwanted vegetation at least as well as, and in some cases superior to, traditional methods of controlling unwanted vegetation through full rate, post-emergent application of a post-emergent herbicide. These results further illustrate the significant reduction in the post-emergent application amount of herbicidally active ingredients necessary for control of unwanted vegetation.

As illustrated by Table 9, unwanted vegetation consumed the entire untreated planting site (Site No. 1). As such, Site No. 1 exhibited 0% control of the unwanted vegetation and crop yield was 57.6 bushels per acre. The traditional treatment scheme was represented by Site No. 17. Specifically, Site No. 17 was not provided with any pre-emergent flucarbazone treatment. Instead a post-emergent rate of 56 grams of active ingredient per hectare (i.e., HORIZON®) was provided to Site No. 17 in a post-emergent application. As illustrated in Table 9, 100% of the planting site was controlled with respect to wild oat and 78% of the planting site was controlled with respect to green foxtail. Further, Site No. 17 provided 70.8 bushels per acre of crop yield.

The total amount of herbicidally active ingredient, according to certain embodiments of the present invention, were shown to be less than the amount of active ingredient necessary to achieve similar results through the traditionally recommended approach for controlling unwanted vegetation by treating a planting site with a post-emergent treatment alone. For example only 43 grams of active ingredient per hectare (i.e., 15 grams of active ingredient per hectare of PREPARE plus 28 grams of active ingredient per hectare of HORIZON®) were used to control the unwanted vegetation in Site No. 6 as compared to the 56 grams of active ingredient per hectare used in Site No. 17. Furthermore, despite utilizing a total reduced amount of herbicidally active ingredient, the percent control of unwanted vegetation in Site No. 6 was similar for wild oat control and more superior for green foxtail control compared to level of control illustrated in Site No. 17 while also providing similar levels of crop yield. Accordingly, the total amount of active ingredient used was about 76% of the amount required by the tradition method.

### Example 10

A study was conducted to test various application methods using flucarbazone-sodium (PREPARE) in a pre-emergent application followed by post-emergent application with pinoxaden (AXIAL™ XL). The results are illustrated in Table 10.

To better evaluate the ability of each treatment scheme in controlling unwanted vegetation in a planting site, a group of nearly identical crop planting sites (Site 1-Site 15) were subjected to different treatment schemes. Treatment rates were based on the lower recommended rate provided on the product label (grams of active ingredient per hectare). Site No. 1 was untreated and represents a control site. Sites Nos. 1-15 received a broad spectrum herbicide, glyphosate, to remove all pre-existing weeds to ensure a more accurate determination of the viability of each treatment scheme. For Site No. 2-Site No. 11, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Site No. 1 was not treated in any manner, allowing wild oat to emerge either with the crop or after crop emergence. Although, Site No. 1 received a pre-burn treatment with glyphosate, this treatment only acts on existing weeds. Thus, Site No. 1 showed 0% weed control. The remaining sites were allowed the same amount of time for weed growth and were visually compared to an untreated crop planting site (Site No. 1). The percent control of wild oat was observed as a comparison to Site No. 1. Thus, percent control for wild oat was evaluated as the weed-free area in the particular site in comparison to the completely weed covered Site No. 1. Further, the respective crop yield for each crop planting site was also recorded.

As referenced in Table 10, glyphosate is a non-residual, broad spectrum herbicide applied to emerged and actively growing weeds. Ammonium sulphate is a commercially available fertilizer blend used as an adjuvant to improve performance of the herbicide. Dicamba is commercially available broadleaf herbicide used to increase the activity and weed spectrum of the pre-emergent herbicides on weeds that have emerged prior to the crop. Tank-mixes for post-emergent application included Adigor. Adigor is an emulsifiable concentrate containing 47% w/w methylated rapeseed oil that helps reduce the surface tension of spray solution on the foliage. Prestige A (fluoroxypyr) and Prestige B (clopyralid+MCPA) are commercially available post-emergent herbicides used for the control of broadleaf weeds in cereal crops.

TABLE 10

| | | | % Control of | |
|---|---|---|---|---|
| | Treatment Scheme and | | Wild Oat at | |
| Site | application rate in grams | | 67 days after | Crop Yield |
| No. | of active per hectare | | application | (Bu./Acre) |
| 1 | Pre-emergent | | 0 | 25 |
| | Glyphosate | 450 | | |
| | Ammonium sulphate | 2% v/v | | |
| | Late Post-emergent | | | |
| | Prestige A | 105 | | |
| | Prestige B | 500 | | |
| 2 | Pre-emergent | | 63 | 31 |
| | Glyphosate | 450 | | |
| | Ammonium sulphate | 2% v/v | | |
| | PrePare | 15 | | |
| | Dicamba | 70 | | |
| | Late Post-emergent | | | |
| | Prestige A | 105 | | |
| | Prestige B | 500 | | |
| 3 | Pre-emergent | | 74 | 34 |
| | Glyphosate | 450 | | |
| | Ammonium sulphate | 2% v/v | | |
| | PrePare | 15 | | |
| | Dicamba | 70 | | |
| | Early Post-emergent | | | |
| | Axial | 15 | | |
| | Adigor Adjuvant | 0.75% v/v | | |
| | Late Post-emergent | | | |
| | Prestige A | 105 | | |
| | Prestige B | 500 | | |
| 4 | Pre-emergent | | 80 | 36 |
| | Glyphosate | 450 | | |
| | Ammonium sulphate | 2% v/v | | |
| | PrePare | 15 | | |
| | Dicamba | 70 | | |
| | Early Post-emergent | | | |
| | Axial | 30 | | |
| | Adigor Adjuvant | 0.75% v/v | | |
| | Late Post-emergent | | | |
| | Prestige A | 105 | | |
| | Prestige B | 500 | | |
| 5 | Pre-emergent | | 78 | 32 |
| | Glyphosate | 450 | | |
| | Ammonium sulphate | 2% v/v | | |
| | PrePare | 15 | | |
| | Dicamba | 70 | | |
| | Early Post-emergent | | | |
| | Axial | 15 | | |
| | Adigor Adjuvant | 0.75% v/v | | |
| | Prestige A | 105 | | |
| | Prestige B | 500 | | |
| 6 | Pre-emergent | | 74 | 42 |
| | Glyphosate | 450 | | |
| | Ammonium sulphate | 2.5% v/v | | |
| | PrePare | 15 | | |
| | Dicamba | 70 | | |
| | Early Post-emergent | | | |
| | Axial | 30 | | |
| | Adigor Adjuvant | 0.75% v/v | | |
| | Prestige A | 105 | | |
| | Prestige B | 500 | | |
| 7 | Pre-emergent | | 83 | 39 |
| | Glyphosate | 450 | | |
| | Ammonium sulphate | 2.5% v/v | | |
| | PrePare | 15 | | |
| | Dicamba | 70 | | |
| | Early Post-emergent | | | |
| | Axial | 15 | | |
| | Adigor Adjuvant | 0.75% v/v | | |
| | Buctril M | 560 | | |
| 8 | Pre-emergent | | 81 | 40 |
| | Glyphosate | 450 | | |
| | Ammonium sulphate | 2.5% v/v | | |
| | PrePare | 15 | | |
| | Dicamba | 70 | | |
| | Early Post-emergent | | | |
| | Axial | 30 | | |
| | Adigor Adjuvant | 0.75% v/v | | |
| | Buctril M | 560 | | |
| 9 | Pre-emergent | | 79 | 37 |
| | Glyphosate | 450 | | |
| | Ammonium sulphate | 2.5% v/v | | |
| | PrePare | 15 | | |
| | Dicamba | 70 | | |
| | Early Post-emergent | | | |
| | Axial | 15 | | |
| | Adigor Adjuvant | 0.75% v/v | | |
| | Deploy | 15 | | |
| 10 | Pre-emergent | | 73 | 38 |
| | Glyphosate | 450 | | |
| | Ammonium sulphate | 2.5% v/v | | |
| | PrePare | 15 | | |
| | Dicamba | 70 | | |
| | Early Post-emergent | | | |
| | Axial | 30 | | |
| | Adigor Adjuvant | 0.75% v/v | | |
| | Deploy | 15 | | |
| 11 | Pre-emergent | | 95 | 37 |
| | Glyphosate | 450 | | |
| | Ammonium sulphate | 2.5% v/v | | |
| | PrePare | 15 | | |
| | Dicamba | 70 | | |
| | Early Post-emergent | | | |
| | Everest | 10 | | |
| | NIS Adjuvant | 0.25% v/v | | |
| | Late Post-emergent | | | |
| | Prestige A | 105 | | |
| | Prestige B | 500 | | |
| 12 | Pre-emergent | | 58 | 35 |
| | Glyphosate | 450 | | |
| | Ammonium sulphate | 2.5% v/v | | |
| | Early Post-emergent | | | |
| | Axial | 15 | | |
| | Adigor Adjuvant | 0.75% v/v | | |
| | Prestige A | 105 | | |
| | Prestige B | 500 | | |
| 13 | Pre-emergent | | 73 | 33 |
| | Glyphosate | 450 | | |
| | Ammonium sulphate | 2.5% v/v | | |
| | Early Post-emergent | | | |
| | Axial | 30 | | |
| | Adigor Adjuvant | 0.75% v/v | | |
| | Prestige A | 105 | | |
| | Prestige B | 500 | | |
| 14 | Pre-emergent | | 85 | 35 |
| | Glyphosate | 450 | | |
| | Ammonium sulphate | 2.5% v/v | | |
| | Early Post-emergent | | | |
| | Axial | 60 | | |
| | Adigor Adjuvant | 0.75% v/v | | |
| | Prestige A | 105 | | |
| | Prestige B | 500 | | |
| 15 | Pre-emergent | | 91 | 37 |
| | Glyphosate | 450 | | |
| | Ammonium sulphate | 2.5% v/v | | |
| | Early Post-emergent | | | |
| | Everest | 10 | | |
| | Prestige A | 105 | | |
| | Prestige B | 500 | | |

Table 10 illustrates that methods according to embodiments of the present invention can provide control of unwanted vegetation at least as well as, and in some cases superior to, traditional methods of controlling unwanted vegetation through full rate post-emergent application of a post-emergent herbicide. These results illustrate the significant reduction in the post emergent application amount of herbicidally active ingredients necessary for control of unwanted vegetation.

As illustrated by Table 10, unwanted vegetation consumed the entire untreated planting site (Site No. 1). As such, Site No. 1 exhibited 0% control of the unwanted vegetation and crop yield was 25 bushels per acre. The traditional treatment scheme was represented by Site No. 14. Specifically, Site No. 14 was not provided with any pre-emergent flucarbazone treatment. Instead a post-emergent rate of AXIAL™ XL of 60 grams of active ingredient per hectare was provided to Site No. 14 in a post-emergent application. As illustrated in Table 10, 85% of the planting site was controlled with respect to wild oat. Further, Site No. 14 provided 35 bushels per acre of crop yield.

The total amount of herbicidally active ingredient, according to certain embodiments of the present invention, can be less than the amount of active ingredient necessary to achieve similar results through the traditionally recommended approach for controlling unwanted vegetation by treating a planting site with a post-emergent treatment. For example, only 30 grams of active ingredient per hectare (i.e., 15 grams of active ingredient per hectare of EVEREST® plus 15 grams of active ingredient per hectare of AXIAL™ XL) were used to control the unwanted vegetation in Site No. 7 as compared to the 60 grams of active ingredient per hectare used in Site No. 14. Furthermore, despite utilizing a total reduced amount of herbicidally active the percent control of unwanted vegetation in Site No. 7 was strikingly similar to that illustrated in Site No. 14.

### Example 11

An additional study was conducted to test various application methods using flucarbazone-sodium (PREPARE) as a pre-emergent application tank-mixed with dicamba, pyraflufen (ET), tribenuron, and carfentrazone (AIM™). The results are illustrated in Table 10.

To better evaluate the ability of each treatment scheme in controlling unwanted vegetation in a planting site, a group of nearly identical crop planting sites (Site 1-Site 10) were subjected to different treatment schemes. Treatment rates were based on the recommended lower rate provided on the product label (grams of active ingredient per hectare). Site No. 1 was untreated to act as a control site. Tank-mix partners with herbicides exhibiting residual soil activity were sometimes applied at more than one rate. Site No. 2-Site No. 10 received a broad spectrum herbicide, glyphosate, to remove all pre-existing weeds to ensure a more accurate determination of the viability of each treatment scheme. For Site No. 2-Site No. 10, glyphosate was tank-mixed with PREPARE and applied to each site prior to the emergence of the desired crop. Since glyphosate is a non-residual (i.e., does not exhibit sufficient residual soil activity to act in a pre-emergent fashion), broad spectrum herbicide that is applied to emerged and actively growing weeds, the application of glyphosate-merely acts to kill any weeds that have already emerged. The application of such a tank-mix can beneficially provide a pre-burn via the glyphosate while simultaneously providing the pre-emergent treatment of a typically recognized post-emergent herbicide according to embodiments of the present invention.

Site No. 1 remained untreated, allowing weeds to emerge and grow. Thus, Site No. 1 showed 0% weed control. The remaining sites were allowed the same amount of time for weed growth and were visually compared to an untreated crop planting site (Site No. 1). The percent control of wild buckwheat and lambs-quarters was observed as a comparison to Site No. 1. Thus, percent control for unwanted vegetation was evaluated as the weed-free area in the particular site in comparison to the completely weed covered Site No. 1.

As referenced in Table 10, glyphosate is a non-residual, broad spectrum herbicide applied to emerged and actively growing weeds. Ammonium sulphate is a commercially available fertilizer blend used as an adjuvant to improve performance of glyphosate.

TABLE 11

| | | | % Control | % Control of |
|---|---|---|---|---|
| | | | of Wild | Lambs- |
| | | | Buckwheat | quarters |
| | Treatment Scheme and | | at 42 days | at 42 days |
| Site | application rate in grams | | after | after |
| No. | of active per hectare | | application | application |
| 1 | Untreated | | 0 | 0 |
| 2 | Pre-emergent | | 80 | 89 |
| | Glyphosate | 450 | | |
| | Ammonium sulphate | 2.5% v/v | | |
| | PrePare | 15 | | |
| 3 | Pre-emergent | | 85 | 94 |
| | Glyphosate | 450 | | |
| | Ammonium sulphate | 2.5% v/v | | |
| | PrePare | 15 | | |
| | Dicamba | 70 | | |
| 4 | Pre-emergent | | 83 | 93 |
| | Glyphosate | 450 | | |
| | Ammonium sulphate | 2.5% v/v | | |
| | PrePare | 15 | | |
| | ET | 0.91 | | |
| 5 | Pre-emergent | | 84 | 92 |
| | Glyphosate | 450 | | |
| | Ammonium sulphate | 2.5% v/v | | |
| | PrePare | 15 | | |
| | ET | 1.83 | | |
| 6 | Pre-emergent | | 85 | 92 |
| | Glyphosate | 450 | | |
| | Ammonium sulphate | 2.5% v/v | | |
| | PrePare | 15 | | |
| | ET | 2.74 | | |
| 7 | Pre-emergent | | 81 | 95 |
| | Glyphosate | 450 | | |
| | Ammonium sulphate | 2.5% v/v | | |
| | PrePare | 15 | | |
| | Tribenuron | 5 | | |
| 8 | Pre-emergent | | 81 | 91 |
| | Glyphosate | 450 | | |
| | Ammonium sulphate | 2.5% v/v | | |
| | PrePare | 15 | | |
| | Tribenuron | 7.5 | | |
| 9 | Pre-emergent | | 84 | 90 |
| | Glyphosate | 450 | | |
| | Ammonium sulphate | 2.5% v/v | | |
| | PrePare | 15 | | |
| | Aim | 8.3 | | |
| 10 | Pre-emergent | | 91 | 95 |
| | Glyphosate | 450 | | |
| | Ammonium sulphate | 2.5% v/v | | |
| | PrePare | 15 | | |
| | Aim | 16.7 | | |

Table 11 illustrates where a typically recognized post-emergent herbicide exhibiting residual soil activity can be utilized in a pre-emergent application according to the present invention. These herbicide tank-mixes help improve the residual broadleaf weed control of flucarbazone when applied in a pre-emergent fashion. More specifically increased weed control for wild buckwheat and common lamb's-quarters was increased with the addition of residual broadleaf herbicides.

Many modifications and other embodiments of the invention set forth herein will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of controlling or preventing unwanted vegetation in a crop planting site, comprising applying to the planting site a post-emergent herbicide, wherein the post-emergent herbicide is applied as a pre-emergent treatment.

2. The method of claim 1, further comprising applying, as a post-emergent treatment, a same or different post-emergent herbicide to the planting site.

3. A method of claim 2, wherein post-emergent herbicide applied as a pre-emergent treatment comprises a compound exhibiting residual soil activity.

4. The method of claim 1, wherein the post-emergent herbicide is applied prior to planting the crop.

5. The method of claim 1, wherein the post-emergent herbicide is applied after planting of the crop but prior to emergence of the crop.

6. The method of claim 1, wherein the post-emergent herbicide is applied both prior to planting the crop and also after planting of the crop but prior to the emergence of the crop.

7. The method of claim 1, wherein the post-emergent herbicide applied as the pre-emergent treatment is selected from the group consisting of sulfonylamino-carbonyltriazolinones, triazolopyrimidines, salts thereof, and combinations thereof.

8. The method of claim 7, wherein the post-emergent herbicide applied as the pre-emergent treatment is selected from the group consisting of flucarbazone, propoxycarbazone, thiencarbazone, pyroxsulam, salts thereof, and combinations thereof.

9. The method of claim 2, wherein the post-emergent herbicide applied in the post-emergent treatment is selected from the group consisting essentially of amides, arylaminopropionic acids, aryloxyphenoxy-propionates, benzofurans, benzoic acids, benzothiadiazole, bipyridyliums, carbamates, cyclohexamediones, dinitrophenols, diphenyl ethers, glycines, imidazolinones, nitriles, N-phenylphthalimides, organoarsenicals, organophosphorus, phenoxyalkanoic acids, phenyl carbamates, ureas, phenyureas, phosphinic acids, pyridine carboxylic acids, pyrimidinyl thiobenzoates, quinoline carboxylic acids, sulfonylaminocarbonyltriazolinones, sulfonylureas, thiadiazoles, triazoles, triazolones, triazolopyrimidines, triketones and salts thereof.

10. The method of claim 9, wherein the post-emergent herbicide applied in the post-emergent treatment comprises clodinafop-propargyl.

11. The method of claim 2, wherein the post-emergent herbicide applied in the post-emergent treatment comprises an organophosphorus herbicide.

12. The method of claim 1, wherein said unwanted vegetation is selected from the group consisting essentially of wild oat, volunteer oat, canarygrass, giant foxtail, Persian darnel, volunteer corn, green foxtail, annual ryegrass, Italian ryegrass, windgrass, cheat, Japanese brome, redroot pigweed, wild mustard, shepherd's purse, durum, yellow foxtail, downy brome, barnyard grass, redroot pigweed, volunteer canola, stinkweed, green smartweed, wild buckwheat and mixtures thereof.

13. A method of controlling or preventing unwanted vegetation in a crop planting site, comprising applying a post-emergent herbicide, wherein the post-emergent herbicide is applied in a pre-emergent treatment, and the post-emergent herbicide is selected from the group consisting of flucarbazone, propoxycarbazone, thiencarbazone, salts thereof, and combinations thereof.

14. The method of claim 13, further comprising applying a same or different post-emergent herbicide to the planting site in a post-emergent treatment.

15. The method of claim 13, wherein the pre-emergent treatment comprises from about 10 grams to about 20 grams of active ingredient per hectare of the post-emergent herbicide.

16. The method of claim 13, wherein the pre-emergent treatment is applied prior to weed emergence at one or more of the following: prior to planting the crop; after planting of the crop but prior to emergence of the crop; or after planting of the crop and after emergence of the crop.

17. The method of claim 14, wherein the post-emergent herbicide applied in the post-emergent treatment is selected from the group consisting essentially of amides, arylaminopropionic acids, aryloxyphenoxy-propionates, benzofurans, benzoic acids, benzothiadiazole, bipyridyliums, carbamates, cyclohexamediones, dinitrophenols, diphenyl ethers, glycines, imidazolinones, nitriles, N-phenylphthalimides, organoarsenicals, organophosphorus, phenoxyalkanoic acids, phenyl carbamates, ureas, phenyureas, phosphinic acids, pyridine carboxylic acids, pyrimidinyl thiobenzoates, quinoline carboxylic acids, sulfonylaminocarbonyltriazolinones, sulfonylureas, thiadiazoles, triazoles, triazolones, triazolopyrimidines, triketones and salts thereof.

18. A method of reducing the amount of a post-emergent activity herbicide necessary for controlling unwanted vegetation in a crop planting site, comprising:
(a) providing a pre-emergent treatment to a crop planting site comprising applying a post-emergent herbicide; and
(b) providing a post-emergent treatment to said crop planting site comprising applying the same or different post-emergent herbicide, wherein the total amount of the post-emergent herbicide applied is no more than 75% of the amount of post-emergent herbicide recommended for post-emergent use with said crop.

19. The method of claim 18, wherein the pre-emergent treatment comprises a compound exhibiting residual soil activity.

20. The method of claim 18, wherein the post-emergent herbicide applied in the pre-emergent treatment comprises a compound selected from the group consisting of sulfonylamino-carbonyltriazolinones, triazolopyrimidines, salts thereof, and combinations thereof.

21. The method of claim 18, wherein the post-emergent herbicide applied in the pre-emergent treatment comprises a compound selected from the group consisting of flucarbazone, propoxycarbazone, thiencarbazone, pyroxsulam, salts thereof, and combinations thereof.

22. The method of claim 18, wherein the pre-emergent treatment comprises application of a compound selected from the group consisting of flucarbazone, propoxycarbazone, thiencarbazone, pyroxsulam, salts thereof, and combinations thereof, and the post-emergent treatment comprises application of a compound selected from the group consisting of clodinafop, flucarbazone, propoxycarbazone, thiencarbazone, pyroxsulam, fenoxaprop, pinoxaden, salts thereof, and combinations thereof.

23. The method of claim 18, wherein the amount of a post-emergent herbicide necessary for controlling unwanted vegetation is reduced by about 25% to about 75%.

24. The method of claim 18, wherein the amount of a post-emergent herbicide necessary for controlling unwanted vegetation is reduced by about 40% to about 60%.

25. A method of reducing the total amount of herbicidally active compounds necessary for controlling unwanted vegetation in a crop planting site, comprising:
(a) applying as a pre-emergent treatment a post-emergent herbicide to a crop planting site at an application rate from about 25% to about 75% of the recommended application rate when used in a post-emergent application; and
(b) applying the same or different post-emergent herbicide to the crop planting site in a post-emergent application at a rate from about 12% to about 75% of the recommended application rate, such that the total amount of herbicidally active compounds is reduced from the amount necessary if applied only in a post-emergent application.

26. The method of claim 25, wherein the post-emergent herbicide comprises a compound selected from the group consisting of flucarbazone, propoxycarbazone, thiencarbazone, pyroxsulam, salts thereof, and combinations thereof.

27. The method of claim 25, wherein flucarbazone or salt thereof is applied in both the pre-emergent treatment and the post-emergent treatment.

28. The method of claim 27, wherein the total amount of flucarbazone applied to the crop planting site is less than the amount of flucarbazone necessary for controlling unwanted vegetation if applied only in a post-emergent treatment.

29. The method of claim 26, wherein the herbicide applied to the crop planting site in the post-emergent treatment is selected from the group consisting of amides, arylaminopropionic acids, aryloxyphenoxy-propionates, benzofurans, benzoic acids, benzothiadiazole, bipyridyliums, carbamates, cyclohexanediones, dinitrophenols, diphenyl ethers, glycines, imidazolinones, nitriles, N-phenylphthalimides, organoarsenicals, organophosphorus, phenoxyalkanoic acids, phenyl carbamates, ureas, phenyureas, phosphinic acids, pyridine carboxylic acids, pyrimidinyl thiobenzoates, quinoline carboxylic acids, sulfonylaminocarbonyltriazolinones, sulfonylureas, thiadiazoles, triazoles, triazolones, triazolopyrimidines, triketones, salts thereof, and combinations thereof.

30. A method of controlling or preventing unwanted vegetation in a crop planting site comprising applying a post-emergent herbicide selected from the group consisting of flucarbazone, propoxycarbazone, thiencarbazone, pyroxsulam, salts thereof, and combinations thereof, to the planting site prior to weed emergence at one or more of the following: prior to planting the crop; after planting of the crop but prior to emergence of the crop; or after planting of the crop and after emergence of the crop.
